(19) United States
(12) Patent Application Publication
(10) Pub. No.: US 2011/0163013 A1
(43) Pub. Date: Jul. 7, 2011

(54) Apparatus and Method for Moving Particles in a Fluid

(75) Inventors: Werner Lurz, Kalterkirchen (DE); Thomas Frischgesell, Luneburg (DE)

(73) Assignee: Eppendorf AG, Hamburg (DE)

(21) Appl. No.: 12/995,157

(22) PCT Filed: May 29, 2009
(86) PCT No.: PCT/EP2009/003878

§ 371 Date: Feb. 22, 2011

Related U.S. Application Data
(60) Provisional application No. 61/057,620, filed on May 30, 2008.

(51) Int. Cl. B03B 5/04; B01F 11/00; B03D 3/04

(52) U.S. Cl. 209/132

(57) ABSTRACT

The invention relates to an apparatus, in particular for moving particles in a fluid at Reynolds numbers larger than 0.5, which comprises a container section adapted to hold said fluid, and which is adapted to perform a displacement process, which includes a number of repeated displacements of said container section, comprises at least one actuating device, which is adapted to perform said displacements, at least one connecting means, which connects said container section to said actuating device, said displacement comprising a first motion of said container section from a first position to a second position and a second motion of said container section from said second position back to said first position, wherein during said first motion said container section is at least temporarily moved with a first velocity, and wherein during said second motion said container section is at least temporarily moved with a second velocity, which is different from said first velocity, and wherein by means of said displacement process, a force is acting upon said particles in the fluid, which is capable of inducing a directed motion of said particles in relation to said container section, wherein said first and second velocity of said container section control, i.e. influence or determine, said motion of the particles. The invention further relates to a method for in particular moving particles in a fluid at Reynolds numbers larger than 0.5.

The present invention relates to an apparatus and a method for moving particles in a fluid in particular at Reynolds numbers larger than 0.5.

Such apparatus are known for example from laboratories where rotating centrifuges are used to perform a centrifugation process on a suspension of particles in a liquid solution. During centrifugation, the difference between the densities of masses of the particles and the solution causes inert forces to act on the masses. In particular, a centrifugal force is generated, which acts on particles, which have a higher mass density than the solution, and separates them from the solution by driving them out of the center of rotation. However, centrifuges require costly mechanics and are bulky devices, which occupy large space in production or research laboratories, and are therefore in particular more difficult to implement in compact automated laboratories or robotic systems. Moreover, the rotor of a centrifuge, which has to be a robust metal construction, provides a high kinetic energy when rotated by typically some hundreds or thousands rounds per minute. A possible operational error, caused by material defects or handling errors, which releases said kinetic energy to the environment thus poses a high potential risk to the user of manually controlled centrifuges.

Other apparatus for separating particles from a fluid use techniques based on acoustic separation. The apparatus of U.S. Pat. No. 5,164,094 is such an example, where particles in a fluid are agglomerated in the node regions or bulge regions of a stationary acoustical field. After the agglomeration, particles are separated from the fluid by sedimentation. Thus, two processes are used to separate the particles from the fluid.

It is an object of the present invention to provide an efficient apparatus and an efficient method for moving particles in a fluid, in particular at Reynolds numbers larger than 0.5. Preferred developments of the present invention are subject matter of the subclaims.

The present invention achieves said object by providing an apparatus according to claim 1 and a method according to claim 38. Further, a sorting device according to claim 36 and a detection device according to claim 37, which implement the apparatus according to claim 1 a computer code according to claim 54 and a storage medium to store operation data for operating the apparatus or the method according to claim 55 are provided.

The apparatus according to the present invention for moving particles in a fluid in particular at Reynolds numbers larger than 0.5, comprises a container section adapted to hold said fluid, and is adapted to perform a displacement process, which includes a number of repeated displacements of said container section, comprises at least one actuating device, which is adapted to cause said displacements, said displacement comprising a first motion of said container section from a first position to a second position and a second motion of said container section from said second position back to said first position, wherein during said first motion said container section is at least temporarily moved with a first velocity, and wherein during said second motion said container section is at least temporarily moved with a second velocity, which is different from said first velocity, and wherein by means of said displacement process, a force is acting upon said particles in the fluid, which is capable of inducing a directed motion of said particles in relation to said container section, wherein said first and second velocity of said container section control, i.e. influence or determine, said motion of the particles.

The capability of the apparatus to move said particles is based substantially on its features to repeatedly displace said container section, wherein during a single displacement, two different velocities are applied to said container section, which comprises the fluid. The resulting force, which can be used to move the particles for purpose of separating them from the fluid or mixing them into the fluid, is a consequence of the fluid-dynamic resistance Fᵣₚ of the particle in the fluid, as will come out from the following description.

In the context of this invention, the term fluid refers to substances that continually deform under an applied shear stress regardless of how small the applied stress. Thus, a fluid is preferably a liquid but is not limited to liquids, and can comprise as well gases, gels and in particular powders, which can behave like a fluid, as well as other flowable solid material. Preferably, the liquid fluid is a biological solution, e.g. cell medium or blood plasma, or a nutrient containing solution (e.g. based on milk, fruit juices or the like), or a chemical solution, based on organic (e.g. carbon containing) or inorganic (e.g. water) solutions and mixtures, which may contain further chemicals, pharmaceuticals, drugs or cosmetics. The fluid can also be a coexistence phase or a mixture of fluids. The apparatus and the method according to the present invention are preferably used with substantially incompressible fluids, e.g. liquids like water or other liquids used in research laboratories.

Particles, in the context of the present invention, preferably are solids or comprise a solid phase. They can also be at least partially gel-like or liquid. Such particles can be beads based on plastics, resins, glass, silicon, ceramics, metal or semiconductor particles, or based on mixtures of such materials. Said particles can in particular be precipitated from chemical solutions or other solid material compounds, which have to be separated from or mixed into a solution, or can be particulate material. Preferably, said particles are biological yeasts, bacteria, cells, like human blood-cells, neurons, osteoblasts or the like. The dimension of said particles is preferably in the range from 0.5 μm to 5 μm, 5 μm to 100 μm, and 100 μm to 1 mm, but can be as well between 1 mm to 10 mm or different. A mixture of particles in at least one fluid involving in particular different Reynolds numbers, can also be appropriate. The Reynolds number, hereinafter ‘Reₚ’, related to the system of a particle in the fluid should in particular at least temporarily be larger than 0.5, wherein the Reynolds number is the ratio of inert forces to viscous forces of said particle in the fluid and, consequently, quantifies the relative importance of these two types of forces for given flow conditions. The Reynolds number of an idealized sphere-like particle in a liquid is commonly defined as

Reₚ=Dₚ*x′ₚ/(μₗ/ρₗ),

wherein Dₚ is the particle diameter, x′ₚ (also ‘vₚ’) is the typical velocity of the particle in the fluid (in particular relative to the position of the container C which contains the particle with the fluid), μₗ is the dynamic viscosity of the fluid and ρ₁ is the specific density of the fluid. For a non-sphere shaped particle, the specific shape contributes to the velocity x′ₚ and thus, to said Reynolds number.

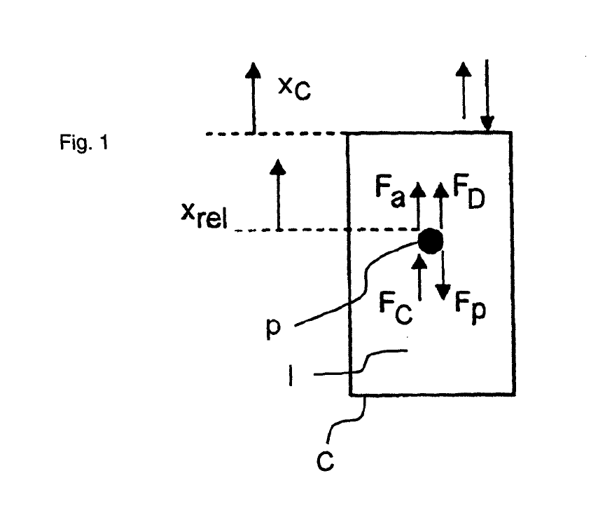

Referring to FIG. 1, the motion of a particle (p) in a liquid (l) in a container (C), which moves up- and downward along the x-axis, is influenced by the weight Fₚ of the particle, the lifting force Fₐ, the liquid friction force F_{D} and the force F_{C} resulting from an accelerated container. Without motion of the container, gravity will cause a slow sedimentation of the particles in solution downwards, wherein the particles have a higher mass density than the solution.

The equation of motion of a particle (p) in a liquid (I) in a moving container is derived as

x″ᵣₑₗ/g=1−ρₗ/ρₚ−x_{C}″/g−(ρₗ/ρₚ*¾*1/Dₚ*1/g*x′ᵣₑₗ²*C_{D}), (equation 1)

wherein
xᵣₑₗ is the location of the particle relative to the container, x′ᵣₑₗ is the velocity of the particle relative to the container, x″ᵣₑₗ is the acceleration of the particle relative to the container, g is the acceleration of gravity (=−9.81 m/s²), ρₗ is the specific density of the fluid, ρₚ is the specific density of the particle, x_{C}, x′_{C} and x″_{C} are respectively the location, the velocity and the acceleration of the container in relation to a static coordinate system, where x indicates the upward direction, Dₚ is the particle diameter and C_{D} is the drag coefficient, wherein

C_{D}=24/Reₚ+4*Reₚ^{-⅓} for Reₚ<1000 and

C_{D}=0.44 for 1000<Reₚ<2*10⁵ (Newton region).

For Reₚ<0.5, the Stokes region, C_{D} is reciprocal proportional to Reₚ, according to C_{D}=24/Reₚ. The fluid-dynamic resistance Fᵣₚ (F_{D}) of a particle with cross section area A at location x in a fluid is defined as Fᵣₚ=1/2*ρₗ*x′²*A*C_{D}. For a sphere-like particle the cross section area is A=(π/4*Dₚ²). Thus, for the Stokes region, the fluid-dynamic resistance Fᵣₚ (stokes)=3*π*μ*Dₚ*x′ₚ is proportional to the velocity of the particle in solution, wherein μ is the dynamic viscosity of the fluid.

An alternative equation of motion of a spherical particle (p) in a liquid (l) in a moving container can be given by

$$\frac{4 π}{3} {r}_{p}^{3} \cdot {ρ}_{p} \frac{d {v}_{p}}{d {t}_{p}} = \frac{4 π}{3} {r}_{p}^{3} \cdot {ρ}_{p} \cdot \frac{3}{8} {C}_{w} \frac{{ρ}_{l}}{{ρ}_{p}} \frac{1}{{r}_{p}} \vert {v}_{l} - {v}_{p} \vert \cdot ( {v}_{l} - {v}_{p} ) + {F}_{a} + {C}_{vm} \cdot \frac{4 π}{3} {r}_{p}^{3} \cdot {ρ}_{l} \frac{d}{d {t}_{p}} ( {v}_{l} - {v}_{p} ) + 6 {r}_{p}^{2} \sqrt{π {ρ}_{l} {μ}_{l}} {\int }_{{t}_{p 0}}^{{t}_{p}} \frac{d / d τ ( {v}_{l} - {v}_{p} )}{\sqrt{{t}_{p} - τ}} d τ \qquad ( equation 2 )$$

In comparison with equation 1, equation 2 accounts for the virtual mass term and the Basset term, which are the last two terms on the right side of equation 2. In equation 2, the motion of the liquid vₗ and the motion of the particle vₚ are described in relation to a stationary coordinate system. In particular, it is not the motion of the particle relative to the container (xᵣₑₗ) which is considered but rather the absolute position xₚ and velocity vₚ (or xₚ′) of said particle in a stationary coordinate system at a time tₚ. In equation 2, rₚ is the particle radius, ρₚ is the particles mass density, C_{D} is the drag coefficient as described above, ρₗ is the liquids mass density, μₗ is the liquids viscosity, Fₐ is the lifting force of the particle, and Cᵥₘ is a modelling factor for the virtual mass and considered to be ½ for a sphere. Not considered in equation 2 are possible effects on the particle due to a possible pressure gradient in the surrounding liquid and effects which are due to the possible rotation of the particle.

The third term on the right side of equation 2 refers to the virtual or added mass and represents the force required to accelerate the mass of the fluid surrounding the particle and moving with it; the increment for a sphere being one half the mass of the fluid displaced (Cᵥₘ). The fourth term on the right side of equation 2 refers to the Basset history integral. The integral term takes into account deviations of the flow pattern from the steady state and is interpreted as an additional flow resistance. Further information on the virtual mass term and the Basset term can e.g. be found in the publication Thomas, Peter J., Experiments in Fluids 23 (1997), 48-53. The disclosure of said article is hereby incorporated to this description by reference.

Neither equation 1 nor equation 2 does exactly describe the real behaviour of a particle in a fluid. They rather are approximations for the “real” situation, which can be useful for carrying out the present invention. Said equation of motion 1 or 2 can be used as a basis for the numerical determination of the location of the particle relative to the container or the absolute location of the particle over time. A numerical solution of the equation of motion can be used to determine the parameters, in particular to determine an appropriate x′_{C} as a function of time, which influence the motion of the particle relative to the container over time in the desired way, e.g. which causes a rapid motion of particles. Moreover, a numerical solution can be the basis for providing control over the apparatus according to the present invention, in particular by predicting the motion of a particle in the fluid without the need to measure the location of the particles in the fluid.

A sinusoidal periodic displacement of the container, which contains the fluid with the particles, along a path x_{C}, which is sinusoidal periodical function of time, implicates that the integral of all external forces acting on the fluid over time is zero, which is described as

∫x″_{C}=0.

Therefore, the external forces acting on the particles in the direction of gravity and against the direction of gravity are the same.

Let the container perform a non-sinusoidal motion, which is a combination of repeated motion x_{C} in x-direction with a first velocity and motion against the x-direction with a—different—second velocity, and which is in particular a periodical saw-tooth-like motion x_{C} with an increasing slope, a maximum point and a decreasing slope in each period. Again, the external forces acting on the particles in the direction of gravity and against the direction of gravity are the same. This is now true for all external forces except from the fluid-dynamic resistance of the particles Fᵣₚ. The fluid-dynamic resistance of the particles Fᵣₚ is first caused by the motion x′ᵣₑₗ of the particles relative to the container and is always acting in opposite to x′ᵣₑₗ. The force Fᵣₚ is dependent on the velocity of the particles relative to the container in the following way:

Fᵣₚ=½*ρₗ*x′ᵣₑₗ²*A*C_{D}

As described above, in the Stokes region of Re<0.5 the fluid-dynamic resistance is proportional to the particle velocity x′ᵣₑₗ. Even a saw-tooth-like displacement x_{C} causes in the Stokes region the same particle motion x′ᵣₑₗ in both directions up and down. However, the more the motion of particles reaches the Newton region (Re>1000) the more different does the fluid react on temporal differences of the velocity of particles x′ᵣₑₗ, because at the same C_{D} a determined velocity of particles x′ᵣₑₗ causes a fluid-dynamic resistance, which is square to x′ᵣₑₗ. Thus, the overall force acting on the particles in the fluid can be different from zero, even though the temporal integral of location, velocity and acceleration of the displaced container is identical to zero, if said first and second velocity of the container are different. The type of a particle in the context of this invention is thus defined in particular by the parameters of the particle, which influence said fluid-dynamic resistance Fᵣₚ, in particular the Reynolds number of said particle for a given velocity x′ᵣₑₗ and the size and shape of said particle. Particles of the same type experience in particular the same value of Fᵣₚ.

Therefore, by means of said displacement process, a force may act upon said particles in the fluid, which is capable of inducing a directed motion of said particles in relation to said container section, wherein said first and second velocity of said container section control, i.e. influence or determine, said motion of the particles. Preferably, the apparatus and the method according to the present invention are adapted such that particles in the fluid move at Reynolds numbers larger than 0.5, to especially maximize said force. Therefore it is preferred to generate displacements of said container sections which cause at least temporarily or at least during repeated periods of the displacement process or during substantially the complete displacement process a Reynolds number larger than 0.5 of particles. Therefore, the apparatus and method according to the present invention are preferably adapted for at least temporarily moving particles at Reynolds numbers larger than 0.5. In order to maximize said force, several preferred embodiments for the displacement process and the particles Reynolds number Reₚ are given below. Preferably, the displacement process is adapted such that the fluid dynamic resistance Fᵣₚ is maximized at least temporarily or at least during repeated periods of the displacement process. It is further preferred that the displacement process is adapted such that said force is maximized. If not noted differently, the Reynolds number Re refers to the particles Reynolds number with respect to the surrounding fluid in the context of the present invention. Preferably, during the first, consecutive, or second motion of the particle in the fluid, the term “Reynolds number” refers to the maximum value Reₘₐₓ of the particles Reynolds number in the fluid, which in particular depends on the particles velocity. Preferably, a first Reynolds number Re₁ is assigned to the first motion and a second Reynolds number Re₂ is assigned to the second or consecutive motion, wherein Re₁≠Re₂.

Thus, by displacing the fluid according to the present invention, a force based on the fluid-dynamic resistance is acting upon particles in the fluid, which is capable of inducing a directed motion of the particles in relation to the fluid, wherein said first and second velocity of the fluid influence or determine the motion of the particles. This unique technique offers a wide field of applications. It allows the apparatus and method according to the present invention to be used in all those technical fields, which require separating, mixing, sorting (according to the particle size or according to the specific particle weight)(or according to the resistive coefficient C_{D}) or transporting particles in a fluid. Preferred fields of applications are the use in research or laboratories, in particular in chemical or life-sciences laboratories, biological or medical laboratories, industrial processes, industrial wastewater cleaning and recycling, industrial raw materials production, colour and lacquer fabrication, treatment of oil- or other hydrocarbon containing fluids, nutrient industry, cosmetics, pharmaceutics and other. An apparatus using this technique can be constructed less costly compared to common centrifuges and is easier to operate at lower operational risks. In particular, the apparatus is compact and can be easier combined with other apparatus and in particular combined with automated systems.

The apparatus according to the present invention is adapted such that said force is capable of inducing a velocity x′ᵣₑₗ of said particles relative to said container section, wherein said force is dependent on x′ᵣₑₗ². Preferably, the apparatus is adapted to perform said displacement process with a periodical repetition of displacements x_{C} according to a displacement frequency f_{C}. However, said repeated displacements are not limited to periodical repetitions and can be at least partially non-periodical repetitions. The repetition of displacements x_{C} is expressed as a function of time x_{C}(t).

An apparatus according to the present invention, in particular for moving particles in a fluid at Reynolds numbers larger than 0.5, comprises: a container section adapted to hold said fluid, wherein the apparatus is adapted to perform a displacement process, which includes a number of repeated displacements of said container section; at least one actuating device, which is adapted to cause said displacements, said displacement comprising a first motion of said container section from a first position to a second position and a second motion of said container section from said second position back to said first position, wherein during said first motion said container section is at least temporarily moved with a first velocity, and wherein during said second motion said container section is at least temporarily moved with a second velocity, which is different from said first velocity, and wherein by means of said displacement process, a force is acting upon said particles in the fluid, which is capable of inducing a directed motion of said particles in relation to said container section, wherein said first and second velocity of said container section control said motion of the particles.

However, it is also possible and preferred that during said displacement process, which preferably comprises many displacements, the container section is displaced such that it is located at a start position before the displacement process starts and is located at a stop position after the displacement process stops, wherein the start position and the stop position can be different. This means in particular, that said displacement can comprise a first motion of said container section from a first position to a second position and a consecutive motion of said container section from said second position to a consecutive position. Said consecutive motion can be equal to said first position, such that the consecutive motion is said second motion, corresponding to a move-back motion (see previous paragraph). Alternatively and preferred, said consecutive position is not equal to said first position and therefore the consecutive motion is not said second motion. However, in the latter case, it is preferred that the consecutive motion, represented by a vectorial quantity, comprises at least a component, which is parallel to said first motion.

Therefore, another apparatus according to the present invention, in particular for moving particles in a fluid at Reynolds numbers larger than 0.5, comprises: a container section adapted to hold said fluid, wherein the apparatus is adapted to perform a displacement process, which includes a number of displacements of said container section; at least one actuating device, which is adapted to cause said displacements, said displacement comprising a first motion of said container section from a first position to a second position and a consecutive motion of said container section from said second position to a consecutive position, wherein during said first motion said container section is at least temporarily moved with a first velocity, and wherein during said consecutive motion said container section is at least temporarily moved with a second velocity, which is different from said first velocity, and wherein by means of said displacement process, a force is acting upon said particles in the fluid, which is capable of inducing a directed motion of said particles in relation to said container section, wherein said first and second velocity of said container section control said motion of the particles (reference to claim 1). A corresponding method is also disclosed (reference to claim 38). For such an apparatus and such a method, said consecutive position preferably is said first position and said consecutive motion is said second motion, which returns said container section back to said first position. Preferably, said first position and said consecutive position of the container section are different.

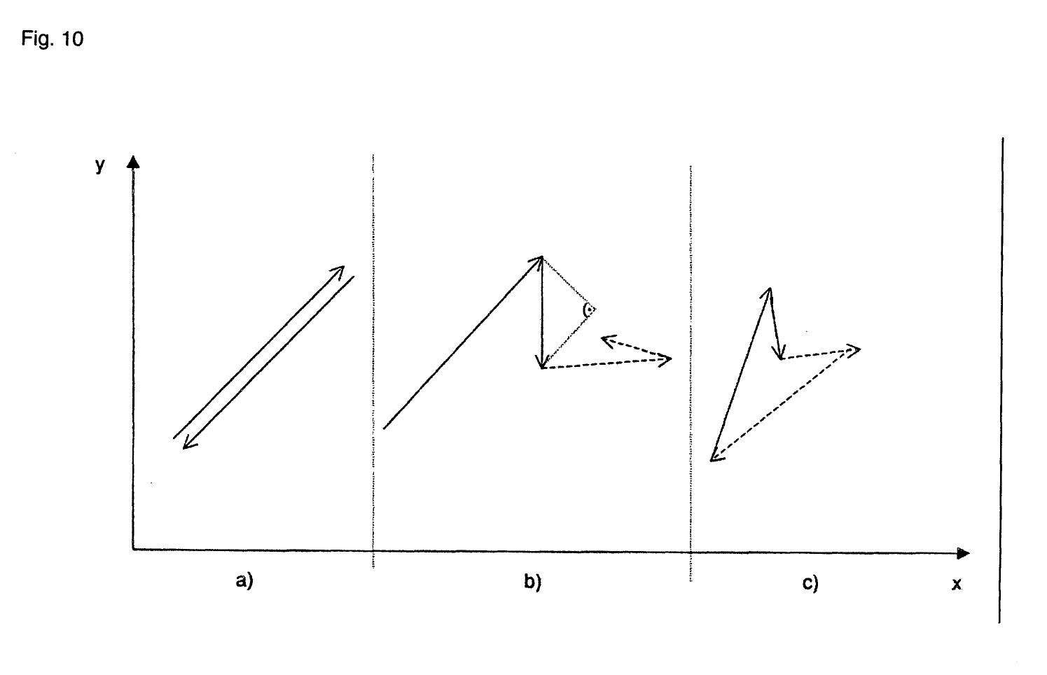

FIG. 10 a) exemplary illustrates the case that said consecutive motion is equal to said second motion, moving the container section forth and back parallel to a direction in the x-y-plane. FIG. 10 b) shows a case where said start and said stop position are different, and where said consecutive motion is not equal to said first motion for each displacement. FIG. 10 c) shows a case where said start and said stop position are equal, and where said consecutive motion is not equal to said first motion for each displacement. In b) and c), each displacement process comprises two displacements (solid line and dashed line), each displacement consisting of two motions, represented by two arrows. For each displacement, the consecutive motion comprises at least a component, which is parallel to said first motion, as shown for the first displacement in b).

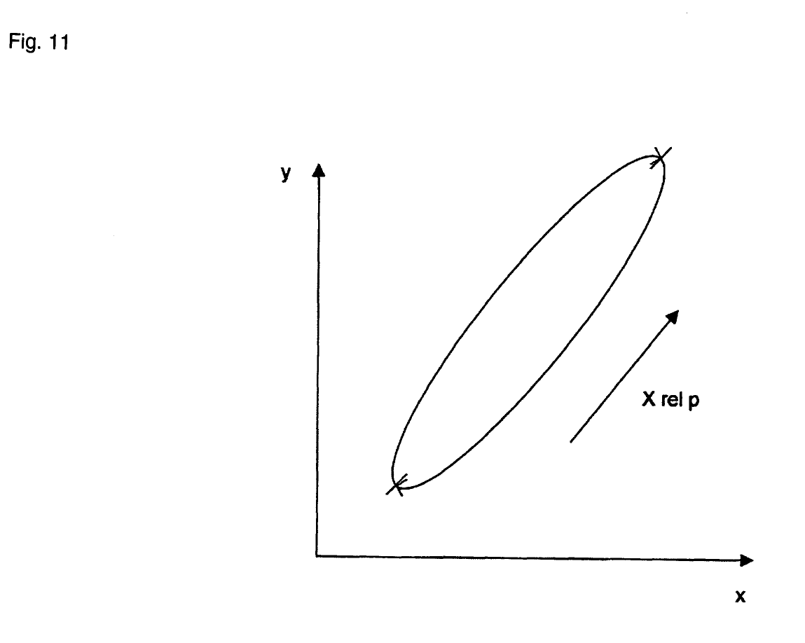

In FIG. 10 a) to c), each motion of the container section is shown to be linear. However, the direction of each motion may change. FIG. 11 shows a case, where a displacement comprises a first and a second (returning) motion, which follow a closed path, which has an ellipsoid form. Such a displacement can also generate a directed motion of a particle in the fluid as indicated by the arrow “x_{rel p}” in FIG. 11. Such a displacement with non-linear motion can be useful for “smoothing” the displacement motion, as the direction of motion of the displacement does not change abruptly over time.

A non-sinusoidal velocity function v_{C}(t) (vectorial quantity) of the container section is preferably provided, which can be described as sequence of temporally consecutive velocity functions v_{C}(t)ᵢ, wherein each v_{C}(t)ᵢ is defined during a time section Tᵢ as a function of time. Herein, period Tᵢ follows after period Tᵢ₋₁. Preferably, v_{C}(t) is a vectorial quantity, which not only represents the absolute value of the temporal course of the velocity of the container section along a single direction, but also contains information on the temporal course of the direction of the velocity of the container section. Preferably, one v_{C}(t)ᵢ corresponds to one displacement of said container section, e.g. forth and back. Preferably, each velocity function v_{C}(t)ᵢ contains at least one first velocity function v_{C1}(t)ᵢ during a sub-period T₁ᵢ and at least one second velocity function v_{C2}(t)ᵢ during a sub-period T₂ᵢ, which follows after said T₁ᵢ. Preferably, each v_{C}(t)ᵢ is an asymmetric function, e.g. T₁ᵢ is preferably not equal to T₂ᵢ and v_{C1}(t); over {0;T₁ᵢ} a is preferably not equal to v_{C2}(t)ᵢ or −v_{C2}(t)ᵢ over {0;T₂ᵢ}.

Said first velocity is preferably said v_{C1}(t)ᵢ and the second velocity is preferably said v_{C2}(t)ᵢ, wherein v_{C1}(t)ᵢ and v_{C2}(t)ᵢ are different. Preferably, the absolute value of v_{C1}(t)ᵢ is larger or smaller than v_{C2}(t)ᵢ. In case of substantially non-constant velocities, the average of v_{C1}(t)ᵢ is larger or smaller than the average of v_{C2}(t)ᵢ. In particular, the time-integral of v_{C1}(t)ᵢ over T₁ᵢ is larger or smaller than the time-integral of v_{C2}(t)ᵢ over T₂ᵢ.

Preferably, sub-period T₁ᵢ corresponds to said first motion, during which said container section is moved from a first position to a second position and preferably, sub-period T₂ᵢ corresponds to said second motion, during which said container section is moved from said second position to said first position.

It is further preferred, that sub-period T₁ᵢ corresponds to said first motion, during which said container section is moved from a first position to a second position and that sub-period T₂ᵢ corresponds to said consecutive motion, during which said container section is moved from said second position to said consecutive position.

Alternatively, the velocity function v_{C}(t) is described as a superposition of velocity functions v_{C}(t)ᵢ, which each shows a characteristic velocity progression during a period Tᵢ. Said characteristic velocity progression comprises a first time section, corresponding to said first motion and a second or consecutive time section, which corresponds to said second or to said consecutive motion.

Preferably, the apparatus is adapted to control the motions of displacement, including said first and second motion, of said container section according to a predetermined pathway, which is expressed by the displacement x_{C}(t) as a function of time. Preferably, x_{C}(t) is a periodical function of time with the period T, the amplitude A and the frequency f_{C}. The amplitude A is preferably adapted to the desired application, in particular adapted to the density of the fluid, the particle and the Reynolds number of the particle in the fluid. The amplitude A is preferably taken from the ranges 0.1 μm to 1 μm, more preferably 1 μm to 50 μm, 50 μm to 100 μm, 100 μm to 500 μm, 500 μm to 2 mm, 2 mm to 10 mm or higher. The amplitude A is preferably smaller than the average dimension of the particles in the fluid. More preferably, the amplitude A is 5 times smaller and particularly preferably 20 times smaller than the average dimension of the particles. However, it is possible that the amplitude A is larger than the average dimension of the particles in the fluid. The frequency f_{C} is preferably adapted to the desired application, in particular adapted to the density of the fluid, the particle and the Reynolds number of the particle in the fluid. The frequency f_{C} is preferably taken from the ranges 0.1 to 1, 1 to 10 Hz, 10 to 99 Hz, more preferably 101 to 500 Hz, more preferably 500 to 1000 Hz, 1000 to 5000 Hz, 5000 to 10000 Hz, 10000 to 20000 Hz, 20000 to 60000 Hz, 60000 Hz to 200000 Hz, 99 to 101 Hz, or higher or lower than said value ranges, which is be chosen to be best applied to the particles and their size, which shall be separated.

Preferably, x_{C}(t) is a non-sinusoidal periodic function. Preferably, x_{C}(t) is a sawtooth-like function or saw-tooth function. A saw tooth-function provides within one period an increasing or decreasing (linear) slope, ended by an edge, which can be lead out/lead in by a substantially vertical section (the term “substantially” includes in particular the case of a vertical section), ended by an edge, and followed up by the next period. A saw-tooth-like function in the context of this invention not only includes saw-tooth function but also other non-sinusoidal periodic functions with periods, which provide an increasing slope and a decreasing slope and do substantially not provide a vertical section, wherein the values of the slopes control the force on the particles in the fluid and thus control the motion of the particles in solution.

Preferably, the displacement x_{C}(t) within each period T comprises a first flank section with a first slope, which is an increasing slope, and a second flank section of a second slope, which is a decreasing slope, wherein said first slope corresponds to said first velocity of said container section and said second slope corresponds to said second velocity of said container section. Further preferred, the absolute values of said first slope and said second slope are different and therefore the absolute values of said first velocity and said second velocity are different, resulting in a force acting upon said particles in the fluid, which is capable of inducing a motion of said particles in relation to said container section. Preferably, the absolute value of said second velocity is higher than the absolute value of said first velocity of the container section, resulting in a force acting upon said particles in the fluid, which is capable of inducing a motion of said particles in relation to said container section in the second direction. Preferably, the absolute value of said second velocity is lower than the absolute value of said first velocity of the container section, resulting in a force acting upon said particles in the fluid, which is capable of inducing a motion of said particles in relation to said container section in the first direction.

For the same predetermined frequency f_{C} and the same amplitude A, the motion of the particles can preferably be increased by further reducing said lower velocity. Also, for the same predetermined frequency f_{C} and the same amplitude A, the motion of the particles can preferably be increased by further increasing said higher velocity. Further, for the same amplitude A, the motion of the particles can preferably be increased by increasing the frequency f_{C}. For the same frequency f_{C}, the motion of the particles can preferably be increased by increasing the amplitude A. In particular, the use of several subsequently applied functions x_{C} allow to control the pathway of the particles in the fluid.

Saw-tooth-like functions in the context of this invention also comprise functions with a substantially saw-tooth-like shape, like described above, wherein sharp edges are at least partially smoothed or the edges and/or slopes are at least partially curved. It is known that sharp edged profiles can excite resonance frequencies in systems, in particular higher frequencies, because the band-with of such sharp-edged profiles is much higher than the band-with of smooth profiles. A smooth progression can be useful to suppress spikes and resonance vibrations, which can be caused by operating the actuating device with a sharp edged profile x_{C}. In particular, considering x_{C} as a periodical function in the Fourier series notation, X_{C} is preferably chosen to neglect the range of higher fourier frequencies. Preferably, the function x_{C} is adapted to a specific application, regarding the physical parameters of the complete system of the apparatus, the container section, the connection device, the fluid with the particles and the actuating device, to achieve efficient motion of particles in the fluid while taking only a reasonable amount of resonances and interfering frequencies. Alternatively, a method to reduce undesired dynamics in the system can be implemented in the apparatus and the method according to the present invention, e.g. the one which is described by WO 90/03009 as “shaping command input to minimize unwanted dynamics”.

Preferably, the displacement function x_{C}(t) and/or the displacement velocity function v_{C}(t) are determined such that during one of said first or consecutive (e.g. second) motion the particle's Reynolds number is closer to the Newton region (Reₚ>1000) than during the respective other motion. In particular, the displacement function x_{C}(t) and/or the displacement velocity function v_{C}(t) are preferably determined such that during said consecutive (e.g. second) motion the particle's Reynolds number is closer to the Newton region (Re p>1000) than during the first motion. When the Reynolds number of the particle gets closer to the Newton region, the fluid-dynamic resistance Fᵣₚ has left the linear Stokes region, where Fᵣₚ is proportional to the velocity of the particle in the fluid, and becomes more non-linear (e.g. quadratic in the Newton region). This non-linearity is the basis for generating forces which can move the particles in the fluid according to embodiment according to the present invention.

In particular, it is possible and preferred that the maximal Reynolds number Re₁ of the particle during said first motion fulfils 0.5<Re₁<5000, preferably 5<Re₁<1000, particularly preferably 50<Re₁<500 and the maximal Reynolds number Re₂ of the particle during said consecutive (or second) motion fulfils 0.5<Re₁<Re₂. It is further possible and preferred that Re₁ fulfils Re₁<0.5 and Re₂ fulfils Re₁<0.5<Re₂. Even in this case, the force which moves the particles is explained by the fact that the Reynolds number, namely Re₂, is larger than 0.5. It is further possible and preferred that Re₁ fulfils Re₁<Re₃ and Re₂ fulfils Re₁<Re₃<Re₂, with Re₂=V*Re₁, wherein Re₃ is preferably chosen from one of the ranges {0.1; 0.5},{0.5; 1}, {1; 2}, {2; 4}, {4; 8}, {8; 20}, {20; 50}, {50; 250} or a different range, and wherein V is a factor which is preferably chosen from one of the ranges {1; 2}, {2; 4}, {4; 6}, {6; 7}, {7; 8}, {8; 10}, {10; 20}, {20; 50}, {50; 100} or V>100.

The container section of the apparatus of the present invention is adapted to hold the fluid, which is to be displaced during the displacement process. Therefore, the container section is a device with at least one carrying structure, like a structured or unstructured bottom wall, membrane or frame, which is capable to hold the fluid and which is capable to displace the fluid upon displacement of the container section. Preferably, the container section comprises at least one, preferably closed or closable, container. Moreover, the container section preferably comprises relative small structures, similar or identical to common sample containers from laboratories, which typically can provide a sample volume in the order of microlitres to (a few tens of) millilitres. In particular, such sample holders are microtiter plates. PCR-plates or multi-wellplates, which are adapted to hold multiple separated sample volumes, e.g. up to 2, 4, 12, 24, 48, 96, 384 or 1536 samples. The invention is not limited but advantageous for such smaller volumes. In particular compared to acoustic particle separation methods, which might require certain minimum fluid volumes and container dimensions to e.g. establish certain standing sound waves, the present invention does not have limitations with respect to the fluid volumes and fluid/container section dimensions and is in particular appropriate for smaller volumes and container sections. Therefore, the size of the container section is not limited to relative small structures and can vary, dependent on the application, from up to 10⁶, up to 10³ and up to 10 litres, and can comprise rather large structures, like chemical reactors, with up to 1, 10, 50, 100 litres, or several hundreds of litres or more.

Preferably, the container section is adapted such that the fluid is not in contact with the actuating device. This is essential e.g. in research or industrial production and analysis, where contamination of the fluid or spreading of an potentially dangerous fluid is to be avoided.

Preferably, the container section is divided into at least two container space sections, in particular into a first and a second container space section, which are adjacent and connected, such that fluid and particles can be exchanged between the first and the second container space section. A container space section can be a space section of the container section. It can provide at least one wall to at least partially separate said container space section from said container section or from another container space section. Such an arrangement can be used to allow simple and efficient mixing or separating of particles.

Preferably, the container section comprises at least one first (container space) section and at least one second section, which is adjacent and connected to said first section, said first and second section being each adapted to hold at least one fluid containing initially, i.e. before separation, a mix of at least two types of particles. Said mix comprises at least one first type of particles, e.g. related to a first Reynolds number, and at least one second type of particles, e.g. related to a second Reynolds number, which is different from said first Reynolds number, the apparatus being adapted to separate said mix of particles by performing a displacement process by means of said at least one actuating device, such that said first type of particles becomes more concentrated in said first section and said second type of particles becomes more concentrated in said second section by said separation. This arrangement is in particular useful if two liquids, each liquid containing a different type of particle, are first mixed, and the mixed particles have to be separated in a later step, in particular without separating the liquids.

Further preferred, the container section comprises at least one first section and at least one second section, which is adjacent and connected to said first section, said first and second section being adapted to hold at least one fluid containing at least two types of particles, i.e. at least one first type of particles, e.g. related to a first Reynolds number, and at least one second type of particles, e.g. related to a second Reynolds number, which is different from said first Reynolds number, said first section being adapted to initially hold particles in high concentration, the apparatus being adapted to mix said particles from said first section of high concentration into said second section by performing a displacement process by means of said at least one actuating device, such that said particles become distributed with a lower concentration in said first and second section. This way, a re-suspension of separated particles can be achieved in the fluid.

The apparatus is adapted to perform a displacement process, which includes a number of repeated displacements of said container section. A displacement comprises a first motion of said container section from a first position to a second position and a second motion of said container section from said second position back to said first position. Preferably, said motion of said container section is performed one-dimensional, i.e. along a line, and preferably performed parallel to the direction of gravity. In this way, a separating motion of the particles can assist or accelerate the sedimentation of particles on the bottom of a container section. However, such a one-dimensional motion of said container section can be directed to other directions, e.g. against or perpendicular to the direction of gravity.

Further preferred, said displacement process comprises several sequences of one-dimensional motions of said container section, each in the same direction, or at least partially in different directions. This allows to define a trajectory xᵣₑₗ(t) of the particles as a function of time, which means that the particles can be moved along an arbitrary path through the fluid. Such an arrangement can be used in lab-on-a-chip applications or other cases where such a directed transport of the particles within the fluid is useful.

It is also possible and preferred that said displacement process comprises one or more displacements, which comprise motions of the container, which are combined motions in x- and y-directions of a Cartesian coordinate system, e.g. along a curved path in two dimensions. Adding another component in the z-direction gives another possibility of further influencing the trajectory of the particles by using a three-dimensional displacement. Such, a radial directed centrifugal force may be combined with a translational acting force to separate the particles in the fluid in more than one direction. In particular, the apparatus according to the present invention with one-dimensional motion of the container section can be combined with a centrifuge, to add an additional component of direction to the sedimentation direction of a centrifuged particle, or to change the sedimentation in the same direction.

The direction of the motion of said particles is preferably dependent on the directions of said first and second velocity of the container section. This is the case, e.g. if said force induced by the displacement process, is not significantly lower than other forces, like gravity, which act on the particle. Preferably, said force induced by the displacement process is the dominant force, which acts on the particle.

The apparatus comprises at least one actuating device, which is adapted to perform said displacements. An actuating device preferably comprises an electrically controllable actuator. Preferably, an actuating device comprises at least one piezoelectric actuator or stack piezoelectric actuator. The piezoelectric actuator can deliver displacements in dependence on the applied voltage with variable amplitudes, in particular between several and some hundreds of micrometers or more, in particular in all three dimensions.

The actuating device preferably comprises at least one actuator or stacked actuator. A preferred actuator device comprises at least one piezoelectric actuator which can deliver displacements in at least one direction, preferably in at least two directions and preferably in at least three dimensions. The actuating device is preferably a shear-effect actuator or comprises at least one, preferably two or three, piezoelectric actuators, which are preferably arranged to deliver displacements in at least one direction, preferably in at least two directions and preferably in at least three dimensions. For example, two or three one-directional piezo actuators can be coupled such that their respective direction of deflection is perpendicular to the respective other(s). Such a coupling can be achieved by using one or more linking elements and fixing the end faces of the actuators thereto. A linking element can comprise an L-shaped surface, wherein the upper end face of a first actuator is fixed to one side of the L and the lower end face of a second actuator is fixed to another side of the L.

Using such more dimensional actuating devices allows to generate a direction of motion of particles in a fluid by means of an appropriate displacement process, which is dependent on the superimposed displacement motion of two, three or more actuators, wherein in particular each actuator contributes a vector component to the overall motion-vector along its one direction of deflection. If using a displacement process which changes direction and/or intensity over time, an arbitrary trajectory of the particle in solution can be achieved. Further, using more than one axis of displacement increases the number of possible applications and embodiments of the apparatus and the method.

Further preferred, an actuating device comprises at least one pneumatic actuator, which converts the energy of a compressed medium, e.g. air, into motion. EP 0 670 962 B1 shows an example of an electrochemical linear motor, which expands and compresses upon application of voltage. Further, the actuating device preferably comprises at least one electromechanical actuator. However, an electromechanical actuator can be any device, which converts electrical energy into kinetic energy.

The actuating device can be constructed using hydraulic, pneumatic, and electromagnetic drives, using piezoelectric and magnetostrictive materials.

The actuating device can be constructed using Dielectric Electro Active Polymers (DEAP), similar to the dielectric actuators disclosed by US 200810038860A1 or WO 2004/027970 A1. Here, electrically controllable actuators based on polymers, e.g. a polymer foil, deforms upon electric stimulation. This can be applied to the apparatus according to the present invention by let such an actuator perform the displacements,

The actuating device can further be constructed using thermally stimulated shape memory (metal) actuators, wherein a deformation of the material occurs upon temperature change. Said tempering can be controlled electrically. Shape memory actuators are often based on copper-zinc-aluminum-nickel-, copper-aluminium-nickel-, and nickel-titanium-alloys.

The actuating device can further be constructed using magnetically controlled shape memory alloys. Actuation of such materials is based on the reorienting of the twin structure of martensite or the motion of austenite-martensite interfaces by an applied magnetic field, which may be generated electrically by electromagnet. Fe-33.5Ni alloy is an example for such an alloy. Further disclosure on actuators based on magnetically controlled shape memory alloys is disclosed by WO 2004/078367 A1.

Moreover, the actuating device can be a magnetic device, which uses magnetic forces to cause said displacement. Such a magnetic interaction may be realized by using electromagnetic elements, like an electromagnet. This offers the advantage that the magnetic field can be changed rapidly and according to a desired rate, thus allowing to apply a desired motion x_{C} of the container section. For example, an electromagnet can be solid mounted and generating a fluctuating magnetic field, while the apparatus, in particular said container section, is adapted to magnetically interact with the fluctuating magnetic field. For example, a permanent magnet or a (e.g. para-, dia- or ferro-) magnetic material can be connected to the container section. Moreover, said magnetic interaction may be realized by using permanent magnet elements, which are arranged in the apparatus to magnetically interact with the container section, which in turn is adapted to magnetically interact with the permanent magnet element. For example, a rotating permanent magnet may be used to cause a displacement of the magnetically interacting container section.

Alternatively, the actuating device may comprise at least one actuator, which is at least partially mechanical. A mechanical actuator, which is adapted to perform a non-sinusoidal, in particular periodic motion, can comprise an excentric. A rotating excentric, mounted between a solid stand and a container section, which is movable mounted in a distance to said solid stand, which are e.g. pressed by a spring against the excentric, can effect a non-sinusoidal displacement of the container section, because the diameter of the excentric between the contact areas of solid stand and container section defines their distance. The choice of an actuating device, which is preferred for a certain application, may depend on the intended amplitude of the displacement, which results in the desired, e.g. maximum, particle motion. Preferably, the actuating device is adapted such that the direction of displacement of the container section is variable and that the displacement of said container section is possible in more than one direction, whereby the direction of motion of said particles in the fluid can be controlled. Preferably, the direction of displacement of said container section is variable in all directions in space, whereby the direction of motion of said particles in the fluid can be controlled. Preferably, the apparatus comprises a plurality of actuating devices, each being connected to said container section and adapted to contribute to said displacement process.

The apparatus according to the present invention preferably comprises a control device, which is adapted to control said displacement process and which is preferably adapted to control said displacement, i.e. said first motion and said second motion of the container section. In particular in the case that the actuating element is an electrically controllable actuator, the control device preferably comprises electrical circuitry, e.g. integrated circuits. The electrical circuitry is preferably adapted to control the functions of the actuating device as well as the operation of the apparatus, which is adapted to perform said displacement process, which means capable of performing the displacement process. Preferably, the control device is adapted to control the motions of displacement, including said first and second motion, of said container section according to a predetermined pathway, which is expressed by the displacement x_{C}(t) as a function of time.

The control device can comprise computing means, e.g. a microcontroller, microprocessor, a field programmable gate array, or the like. The control device can be adapted to be operated utilizing computer program code, e.g. a firmware, which in particular can be adapted to control the motion of the container section during the displacements x_{c}(t), v_{C}(t). The control device can further comprise a data memory for temporarily or long-term storage of data, e.g. data for operating the apparatus, the actuating device or other devices. The control device can further comprise additional control elements, which can be connected to the control device or to the actuating device, and in particular between the control device and the actuating device. A control element can comprise electrical circuitry and can comprise a power supply unit for supplying the actuating device or other devices with electrical energy. The control device can further comprise a power supply unit for supplying the apparatus, the actuating device or other devices with electrical energy. The apparatus or the control device can further comprise cooling devices like thermoelectric elements (peltier) or ventilators to cool the power supplies, power consumers, in particular the actuating devices. The control device can further comprise data input/output devices and data interfaces, to allow communication between the control device and internal and/or external devices like data storage media, computer or other apparatus. Said data input/output devices and data interfaces are preferably adapted to exchange operational data of the apparatus, which can be data on the physical parameters like x_{C}, A, f_{C}, which control the displacement process. Said operational data can further comprise timing data for starting and stopping the displacement process.

Preferably, the control device is adapted to start/stop the displacement process upon receipt of a start/stop signal. The start (stop) signal may be initiated by operation panels, which can be part of the apparatus and which allow user interaction with the apparatus, or it may be initiated by the control device, which can be connected to an internal or external timer or another control system, e.g. a computer or the control system of an automated system. It is further preferred that the control device is part of another control device, which is adapted to control further functions of the apparatus or of other apparatus. Preferably, the apparatus is adapted to be controlled by an external control device, which is arranged outside the apparatus. Therefore, the apparatus preferably comprises an interface for unidirectional or bidirectional exchange of signals, e.g. signals for controlling the actuating device. Preferably, the control device is part of an external control device, which is arranged outside the apparatus. Preferably the control device is assigned to the control of an laboratory information management system (LIMS) or LIS (laboratory information system) or any similar system and in particular any at least partially automated system, which is adapted to control more than one laboratory operation, in particular such operations which are related to instruments, which are integrated into a laboratory network.

The apparatus preferably comprises a holder element, which may be a solid stand, arm, movable stand or arm, or lift, which holds said actuating device. In particular, the actuating device and the at least one container section of the apparatus may be suspended to a solid stand, an arm, movable arm or lift, which in particular can be as well part of an automated system. Such an implementation of the apparatus according to the present invention into an existing system, e.g. an automated system, has the advantage that processing of fluids containing particles is simplified. In particular, particles could be separated from or mixed into a fluid without the need to remove the fluid from the system in order to process the fluid with a separate device. In particular, the holder element could be used additionally to transport the at least one container section between locations in a system.

Moreover, the apparatus may comprise a second holder element, which is arrangable or mountable (and/or removable) to the actuating device and arrangable to hold the at least one container section. The second holder element can in particular provide the function of a connecting device, which connects said container section to the actuating device. The second holder element could be a plate, a rack or a block, e.g. comprising at least one recess, which is formed to hold a container section comprising at least one container or multiple containers, e.g. a microtiter plate, by a form-closed connection. The second holder element, said container section, said container and/or said multiple containers are each preferably composed of—or at least each preferably provide—a material, which is chosen according to a desired application. The choice of said material can be in particular based on the frequencies of applied periodic displacements x_{C}. Preferably, in particular for frequencies in the kHz range and higher frequencies, said material is a stiff and light material. Said material may be a composite material comprising carbon-, glass-, aramid fibre or the like or comprises said composite material. Moreover, said material maybe a plastic, in particular a thermoplastic, e.g. polypropylene, or metal, e.g. aluminium or steel, and is preferably a ceramics or sintered ceramics. However, said second holder element can be also composed of—or at least provide—a material, which has a higher density, like aluminium, silver or steel. Using a material with proper parameters of heat capacity and heat conductance, e.g. said metallic materials, also allows to control the temperature of the second holder element, the at least one container section and/or the fluid, in particular by optionally using tempering devices, e.g. Peltier elements.

Moreover, the holder element or the second holder element can be at least partially elastically deformable to provide attenuation to the motion of displacement of the container, to eliminate or attenuate undesired spikes, crushes and vibrations, which may interfere with the desired motion of the particles in solution.

The apparatus preferably comprises at least one connecting device, which connects said container section to said actuating device. The connecting device can be a device, which allows to removable or irremovable connect the container section to the actuating device. Preferably, the connecting device comprises a connecting structure, which to a first side can be welded, glued, integrally connected or otherwise anchored to the actuating device or said second holder element, and which to the other side can be preferably removable connected to said container section. The connecting device can comprise clamp elements, engaging elements, screws or the like to removably connect the container section. Alternatively, the apparatus and the container section can be configured to provide magnetic connection means to removably connect the container section to the actuating device. Further preferred, the connecting device comprises a vacuum device to hold the container section to the actuating device by vacuum and an aspiration hole, which can be provided by the connecting device. Using a vacuum provides a flexible type of connection with high reliability and simple operation, which is in particular useful for automated systems with a high throughput.

Preferably the apparatus is adapted to provide a movable arrangement of the container section relative to the actuating device, e.g. by using a movable interface. For example, the movable interface can comprise springs, joints or other deformable or movable elements, which support the container section.

It is further preferred that the apparatus does not comprise a connection device which connects the actuating device and the container section. In this, case the apparatus is adapted to let the actuating device interact with the container section with or without physical contact. Preferably, the apparatus comprises a contact section, which is adapted to mediate the motion of the actuating device to the container section. Preferably, the actuating device is provided with a contact section, which can be a support, e.g. a plate, which holds the container section just by gravity. For example, a sample container with a fluid including particles can be placed on a support, which causes the displacement of the sample container in said first direction, while the motion in said second direction is caused by gravity. This allows a simple construction of the apparatus, reducing cost and maintenance. Said contact section is preferably made of—or at least provides—a material, which can be the same material, which is preferably chosen for the second holder element, as described above.

The apparatus and the method according to the present invention and their respective embodiments and modifications can be used to construct a sorting device, which preferably comprises the apparatus according to the present invention and preferably applies the method according to the present invention, for sorting particles according to a physical parameter. The force, which is generated and acting upon particles in the fluid due to differences in the fluid-dynamic resistance Fᵣₚ, and the motion xᵣₑₗ of the particles relative to the container section depend on the Reynolds numbers Reₚ of the particles, which itself e.g. depends on its resistive coefficient C_{D} or its diameter. A sorting device can sort particles according to their Reynolds number, and thus, preferably according to their diameter. The displacement process for sorting can comprise a motion x_{C}(t) or v_{C}(t) which causes a directed force of said particles in the fluid in a direction dₓ, which is parallel to the direction of gravity (i.e. vertical) or inclined or perpendicular to the direction of gravity. In the perpendicular case, sedimentation can be observed and utilised separately from the motion, which is induced by Fᵣₚ. To achieve this, the displacements are preferably performed along the direction dₓ.

Therefore, a sorting device is provided, in particular for sorting particles in a fluid at Reynolds numbers larger than 0.5, which comprises a container section adapted to hold said fluid, and is adapted to perform a displacement process, which includes a number of repeated displacements of said container section, comprises at least one actuating device, which is adapted to cause said displacements, said displacement comprising a first motion of said container section from a first position to a second position and a second motion of said container section from said second position back to said first position, wherein during said first motion said container section is at least temporarily moved with a first velocity, and wherein during said second motion said container section is at least temporarily moved with a second velocity, which is different from said first velocity, and wherein by means of said displacement process, a force is acting upon said particles in the fluid, which is capable of inducing a directed motion of said particles in relation to said container section, wherein said first and second velocity of said container section control, i.e. influence or determine, said motion of the particles, wherein preferably a distribution section is provided to hold the fluid, which is assigned to the container section.

Correspondingly, a method for sorting particles, in particular in a fluid at Reynolds numbers larger than 0.5, is provided, comprising the steps: holding said fluid with said particles in a container section; performing a displacement process, which includes a number of repeated displacements of said container section, by means of said actuating device; performing said displacement by performing a first motion of said container section from a first position to a second position and a second motion of said container section from said second position back to said first position by means of said actuating device, wherein during said first motion said container section is at least temporarily moved with a first velocity, and wherein during said second motion said container section is at least temporarily moved with a second velocity, which is different from said first velocity, applying a force by means of said displacement process upon said particles in the fluid, which is capable of inducing a directed motion of said particles in relation to said container section, wherein said first and second velocity of said container section control said motion of the particles; and using said motion of the particles to distribute the particles in a distribution section.

The distribution section is adapted to let the particles in the fluid distribute along at least a first direction d₁, which can be the direction of gravity or perpendicular to gravity or inclined under an angle α_{d1} against gravity. Further, the distribution section is preferably adapted to let the particles in the fluid distribute along at least a second direction d₂, which can be the direction of gravity or perpendicular to gravity or inclined under an angle α_{d2} against gravity.

The distribution section can comprise an open, closed or closable chamber, which besides its three-dimensional nature extends along a characteristic direction d₁, d₂ or more directions. The chamber preferably has a capillary shape, e.g. cylindrical, and/or a cuboid shape and/or a cuvette shape, which preferably extend along a characteristic direction d1. Moreover, it can have a cube shape with a depth, a width and a height, in particular the shape of a flat cube. A flat cube can be a cube with a height-to-width-ratio smaller than 0.5 or smaller than 0.1. The cube besides its three-dimensional nature preferably extends along a characteristic direction d₁, e.g. the depth, and along a characteristic direction d₂, e.g. the width. A direction d₃ is assigned to its height.

The chamber can be transparent and can comprise materials which allow optical trans-mission measurements being applied on the transparent chamber, e.g. transparent plastic, glass, quartz or fused silica.

The distribution section preferably comprises structure elements, which structure the space of the distribution section and therefore structure the space which is accessible for the fluid. Structuring elements can be solid or hollow parts, which can be arranged in the chamber. Structuring elements can be used to assist the sorting process by structuring the space, which is available for the fluid and which is therefore available for possible trajectories of motion of the particles. Further, structuring elements can be used to collect the particles from the space of the distribution section. For example, receptacle-like structure elements can be used to recover particles, which move into the receptacles driven by a force, e.g. gravity or the force effected by differences in Fᵣₚ during the displacement. The structuring elements can be fixedly mounted, e.g. integrally formed, or can be detachably mounted to the distribution section.

The distribution section can comprise at least one opening, preferably a plurality of openings, which are preferably distributed and arranged on a side of the distribution section, e.g. the bottom side. The openings can be holes in the wall of a chamber. The openings can be configured to be closable by providing closing means. Such closing means can comprise valves or shutters. Channel elements like tubes or flexible tubes can be provided and are preferably mounted or mountable to said openings, to allow the transport of fluid with particles. This allows further processing of the fluid with particles, e.g. to analyse the fluid with particles by optical measurements or to recover the particles.

A detection device is provided, comprising the sorting device, and further comprising detection means to detect at least one physical property of one type of the particles in the fluid, which are sorted by means of the sorting device. Further a detection method is provided, comprising the steps of the sorting device and comprising the step of detecting at least one physical property of one type of the particles, which are sorted by means of the sorting device, by detection means. Using the detection device and method, a type-spectrum of a particle mixture can be achieved, i.e. the spatial distribution in dependence of any parameter, which is characteristic e.g. for the particle type and which influences Fᵣₚ.

The detection means preferably comprise electrical detection means, e.g. means for producing an electrical field through the fluid with the particles and/or means for detecting the changes of the electrical field, which can occur due to changes of the dielectric property of the fluid, caused by the particles. The electrical detection means can in particular comprise means for performing impedance measurements on the fluid with the particles. Further, the detection means preferably comprise optical detection means, which can comprise a radiation source, e.g. an Laser, LED, a vapour discharge lamp, infrared source, UV or X-ray source, preferably in combination with an appropriate radiation detector, e.g. photodetector capable of converting light into either current or voltage, like a photodiode or a CCD-detector. Such an arrangement can be used to determine e.g. the extinction of radiation e.g. by determining the mass attenuation coefficient of the fluid with particles according to the Beer-Lambert Law, to infer the concentration of the particles in the fluid, in particular the particle concentration of a sorted fraction of the particles. Further, the absorption of X-rays by the particles can be monitored to infer the concentration of the particles in the fluid. Light scattering techniques, e.g. laser light scattering, may be used to determine the size of the particles, in particular the particle size of a sorted fraction of the particles. However, other detection means, in particular means to determine the particle size or particle concentration can be used.

The physical property of one type of the particles to be detected can be the particles size, the particles density, the particles shape or the degree of agglomeration of particles or a combination of such parameters.

The detection method preferably comprises a calibration step, which preferably is applied before running the detection method on the particle (mixture) to be sorted and detected. The calibration step allows to finally relate the distribution of the particles in the distribution section, e.g. the particles position in a chamber, to the physical property, e.g. the size, of the particle which is to be detected, by comparison with the behaviour of a known test system. The calibration can be performed by applying a known (mixture of) test particles to the detection device and the detection method. The known physical properties of the test particles can comprise a known size composition of the test particles. The expected distribution in the distribution section of the test particles in dependence on the physical property (size) is known because e.g. determined before. Thus, the distribution of the test particles generates a scale for the particles to be tested, wherein said scale relates the distance covered by a type of particle upon its “directed motion” to the physical property (e.g. size) of the particle. The test particles are preferably chosen to be an adequate comparison to the kind of particles to be tested. E.g., polystyrene particles with a density similar to biological cells can be appropriate to compare with biological cells. Such a calibration system can be used to determine the cell sizes. The calibration scale or calibration scale pattern can comprise experimentally data and/or calculated, e.g. inter- and extrapolated data.

A sorting device and a sorting method can be realized by generating a motion x_{C}(t) and respectively a velocity v_{C}(t) of the container section, which is parallel to said direction d₁ and/or d₂. This way, a directed motion of the particles along direction d₁ or as a trajectory in the plane defined by directions d₁ and d₂ or in 3D-space can be induced. Further, gravity and sedimentation can be used to collect particles on the bottom of the distribution section or in receptacle-like structure elements, arranged at the bottom of the distribution section. In this case, the sedimentation period due to gravity is preferably substantially the same for all particles, while their pathway x_{rel p}, which is induced by the apparatus or method according to the present invention, is dependent on the size-dependent Reynolds numbers.

In a further example for the sorting method, at the begin of the sorting, a mixture of particles may be dropped to the fluid or released to the fluid, e.g. by opening a closure between a first container space section, which initially contains all particles, and an adjacent second container space section, which initially contains no particles. To ensure a predetermined sedimentation pathway, particles start from a height h over the bottom of the container. During the displacement process, particles are moved in a direction e.g. perpendicular to gravity by a distance, which depends on the Reynolds number. Mounted or measured along the pathway of motion, a scale may indicate said distance. The amount of particles, which concentrate in a certain distance from the starting position on the bottom of the container, is a measure of the amount and/or concentration of said type of particle in the fluid and in the initial mixture of particles. This way, the Reynolds number distribution and/or the size distribution of the particles in a mixture of particles can be determined. Preferably, the sedimentation speed of the particles is observed, e.g. optically observed, preferably dependent on said distance, which allows to also account for effects due to different particle masses.

Another problem of apparatus with a container section, which contains a fluid, in particular laboratory apparatus which handle a liquid fluid, rises from the fact that the fluid tends to spread inside the container section. This is the case for example for a liquid fluid, which in the ideal case is concentrated as bulk in a lower section of the container section by gravity and attractive Van der Waals forces of the fluid. However, due to vibrations or condensation, the liquid fluid may spread away from the fluid bulk to the upper section of the container section, in particular to the inner side of a container or cap of a container. This states a problem for certain applications, where e.g. condensation leads to a change of the concentration of particles or reactants in the fluid and where at the same time error tolerances for the data analysis are low.

Said problem exists for example for PCR-systems, where a laboratory apparatus performs a polymerase chain reactions (PCR) and in particular performs a quantitative (real-time) PCR, said PCR systems being widely used e.g. in medical diagnostics and research. For said apparatus, it is common to use a heated cover plate, which covers and thermally contacts the upper section of the sample containers, i.e. the caps or cover sheet. By applying a temperature to the upper section of the sample container, which is higher than the temperature of the sample liquid, condensation of liquid at the inner wall of the upper section is avoided. In particular, devices for performing a real time quantitative PCR require that condensation at the upper section is avoided, because for said application the cap is used as a part of an optical path for monitoring the progress of the PCR by exciting and measuring the fluorescence from dyes in the sample through the cap. Thus, it is important to avoid condensate at the upper section, which may interfere with the optical measurement.

In order to solve said problem, the apparatus according to the present invention is adapted in a preferred embodiment according to the invention so as to perform a shaking motion of said container section. Preferably, the apparatus is adapted to perform a displacement process, which is adapted to perform a shaking motion of said container section. In particular said first motion and said first velocity and said second motion and said second velocity are adapted to perform a shaking motion of said container section.

Using the definitions and explanations of the whole description, an apparatus for performing a shaking motion comprises a container section adapted to hold a fluid and is adapted to perform a displacement process, which includes a number of repeated displacements of said container section, comprises at least one actuating device, which is adapted to cause said displacements, said displacement comprising a first motion of said container section from a first position to a second position and a consecutive motion (in particular: said second motion) of said container section from said second position to a consecutive position (in particular: back to said first position), wherein during said first motion said container section is at least temporarily moved with a first velocity, and wherein during said consecutive (second) motion said container section is at least temporarily moved with a second velocity, which is different from said first velocity, wherein said first motion and said first velocity and said second motion and said second velocity are adapted to perform a shaking motion of said container section. Protection is hereby claimed for such an apparatus for performing a shaking motion, in particular independent from the apparatus according to claim 1.

Moreover, protection is claimed for a method for performing a shaking motion, comprising the steps: holding said fluid with said particles in a container section; performing a displacement process, which includes a number of repeated displacements of said container section, by means of said actuating device; performing said displacement by performing a first motion of said container section from a first position to a second position and a second motion of said container section from said second position back to said first position by means of said actuating device, wherein during said first motion said container section is at least temporarily moved with a first velocity, and wherein during said second motion said container section is at least temporarily moved with a second velocity, which is different from said first velocity, wherein said first motion and said first velocity and said second motion and said second velocity are adapted to perform a shaking motion of said container section.

Such an apparatus and method for performing a shaking motion are each preferably configured to be usable for moving particles in a fluid with at Reynolds numbers larger than 0.5 in a fluid, such that by means of a displacement process, a force is acting upon said particles in the fluid, which is capable of inducing a directed motion of said particles in relation to said container section, wherein said first and second velocity of said container section control said motion of the particles. Said displacement process is preferably different from said displacement process, which is adapted to perform a shaking motion. However, it is possible to use the same displacement process for both, performing a shaking motion and moving particles in the fluid. Preferably, the apparatus for performing a shaking motion is adapted to temper the fluid by tempering means, e.g. Peltier elements, and is preferably adapted to perform a PCR, e.g. by performing tempering cycles on the fluid by means of programmable electric circuitry.

Such a shaking motion is appropriate to shake off particles or liquid drops from a container wall, wherein said drops can in particular be condensate from the condensation of said fluid or other liquids on the wall of a container, which comprises said container section. Said wall can be in particular the inner wall or inner side of the cap of a sample or reaction container. Such an arrangement of the apparatus according to the present invention is in particular useful for samples and reactions, which require an accurate keeping of a specific concentration or which require that the inner walls of said container section are free from drops. This is the case e.g. for polymerase chain reactions (PCR) and in particular for the quantitative (realtime) PCR. The containers, which are usually used for performing a PCR reaction, e.g. the wells of a PCR plate, are typically made of a material, which has a bad wettability for water and is rather hydrophobic. This means that the adhesive forces between the container material and the liquid are rather weak, in particular weaker than for a hydrophilic material. The higher said adhesive forces are, the more difficult is the removal of drops from a wall by a shaking motion.

In another configuration, the apparatus and method according to the present invention can be adapted to move drops on top of a substantially horizontal substrate, e.g. by using a saw-tooth-like function x_{C} along a horizontal direction.

The initial adhesion of a drop to a wall can be interpreted as a static friction of an object, which is usually higher than the dynamic friction of the object, which is sliding along a wall. Shaking off a drop from a wall of the container section requires that the adhesive force between the container material and the liquid are overcome and that the drop is driven against the dynamic friction into the bulk of the liquid. This can be achieved by the appropriate choice of said displacement process, in particular of said first and second motion and said first and second velocities. It is preferred that the displacement process comprises an impact-like motion of the container section, which is provided preferably at the begin of the displacement process. An impact motion is a motion, which is performed (i.e. started or stopped) almost instantly, i.e. within a short time period. The impact force acting on a moving mass m, which e.g. decelerates (=negatively accelerates) or stops the mass or (positively) accelerates the mass, is F=m*dv/dt, wherein dv is the speed difference of the moving mass before and after impact and dt is the time required for the impact. An impact-like motion is a motion, which at least substantially provides the character of an impact or is an impact motion. The impact-like motion is appropriate to overcome said adhesive forces by an impact force.

A high impact force can for example be achieved by letting the mass (the drop) move with a certain first velocity, followed by an abrupt stop. An abrupt stop can occur by inverting the direction of motion of the container section without having a time period without motion. However, it is possible that there is also a time period of said abrupt stop, where the container section does not move relatively to the ground. Thus, an initial velocity has to be reached before impact. This can be achieved by accelerating the drop, which initially rests on a wall, e.g. an inner side wall, of the container section. However, accelerating the container section in a way that F=m*a is higher than the vertical component of the adhesive force, will not transfer an impulse from the container section onto the drop. The drop will rather keep its absolute position in space due to inertia—overriding the adhesion—while the container section moves downwards (downwards=towards the earth centre of gravity). As a result, the drop would move in the wrong direction. Therefore, the drop has to be accelerated first with a low acceleration a_{low}, which causes a force F=m*a_{low} to act on the drop, which is lower than the vertical component of the adhesive force and which moves the drop with the container section to a first velocity. In order to achieve a high first velocity at low acceleration, the distance, which is available for the acceleration, has to be possibly large and the time period of acceleration has to be large. Thus, it is preferred that the amplitude of the first motion, which is the distance between said first and said second position, is high. The exact values may be chosen experimentally according to the desired application. A possible amplitude is for example in the range from 0.01 mm to 10 mm, preferably between 0.1 mm and 1 mm and preferably between 0.1 mm and 0.5 mm. Said first velocity at impact is respectively preferred in the range between 0.01 m/s and 100 m/s, 0.01 m/s and 10 m/s, 0.01 m/s and 1 m/s, 0.1 m/s and 1 m/s or 0.1 m/s and 10 m/s.

At the end of said first motion, the container section with the drop is at least temporarily moved with a certain first velocity, before the first motion of said container section is stopped within a short time (impact). Due to the impact, the inert force of the drop F=m*dv/dt keeps the drop moving in the same direction, i.e. toward the liquid bulk, assisted by gravity. Once the drop is in motion, e.g. sliding down the inner wall of the container section, the subsequent second motion, directed upward, which resets the actuating device to its starting position, and all subsequent motions have to be configured such that the drop keeps running down the wall, until it reaches the bulk. However, it is possible that the drops already reaches the bulk due to the impact-like motion. A fast second motion upwards will further increase the drop speed relative to the wall of the container section by adding the upward velocity to the drop speed. Moreover, keeping the average time of upward motion in a displacement process small, involves that the time period, during which the vertical component of the adhesive force might contribute to a force, which acts upward on the drop, is relative short, thus reducing the total work of moving the drop upward. In turn, keeping the average time of downward motion in a displacement process to take longer, involves that the time during which the vertical component of the adhesive force might contribute to a force, which acts downward on the drop, is longer, thus increasing the total work of moving the drop downward due to adhesion. Thus, a longer average downward travel time of the container section between said first and second position leads to a net downward work due to adhesion. Said second velocity is preferably faster than said first velocity, in particular faster than said first velocity at the time of impact. Said second velocity is preferably determined by multiplying said first said first velocity by a factor, which is preferably a real number in the range respectively preferred between 1.0 and 100.0, 2.0 and 50.0 or 5.0 and 10.0. However, it is also possible and preferred to use a factor smaller than 1.0. In this case the second velocity is slower than said first velocity.

In summary, the displacement process x_{C} in an apparatus or a method for performing a shaking motion preferably comprises an impact like motion, which comprises a relative slow accelerated downward motion, which is finished with an abrupt stop of the motion. Thus, the first motion preferably is a downward motion with a relative slow first acceleration, ending at a certain first velocity of the container section, followed by an abrupt stop, and an upward motion, comprising a second acceleration which is higher than said first acceleration. The displacement process x_{C} preferably comprises a repetition of displacements, wherein, preferably for each displacement, the first motion from said first to said second position refers to a downward motion and the second motion from said second to said first position refers to an upward motion, and wherein the time period of said first motion is longer than the time period of said second motion. Said second velocity is preferably faster than said first velocity.

Therefore, it is preferred to provide an apparatus/a method for performing a shaking motion or to provide a combination of the apparatus and/or the method according to the present invention, which is additionally or alternatively capable of performing a shaking motion, is preferred. To allow said shaking motion, the respective apparatus is preferably provided with the capability of a displacement x_{C}, which is a function of time, to efficiently shake off drops from a container wall or a cover/cap of said container. Preferably, such a displacement x_{C} is also appropriate to perform the displacement process according to the present invention, which is capable of moving particles in a fluid. However, it is possible and preferred that the displacement x_{C}, which is optimized to shake off drops, is not adapted to move particles in the fluid. In this case, the displacement x_{C} for a shaking motion is preferably stored as an alternative data profile x_{C} in the apparatus according to the present invention and preferably stored in a data memory of the apparatus according to the present invention. It is further possible and preferred that the apparatus, which is used to perform the shaking motion, is not adapted to perform a displacement process according to the present invention, which is capable of moving particles in a fluid.

Using the explanations and definitions of the description of the present invention, the following embodiments and uses of the apparatus according to the present invention are provided:

The apparatus according to the present invention wherein the direction of the motion of said particles is dependent on the directions of said first and second velocity.

The apparatus according to the present invention wherein the apparatus is adapted such that said force is capable of inducing a velocity x′ᵣₑₗ of said particles relative to said container section, wherein said force is dependent on x′ᵣₑₗ².

The apparatus according to the present invention wherein it is adapted to perform said displacement process with a periodical repetition of displacements according to a displacement frequency f_{C}.

The apparatus according to the present invention wherein it comprises a control device.

The apparatus according to the present invention wherein it comprises a control device, which is adapted to control said displacement process.

The apparatus according to the present invention wherein it comprises a control device, which is adapted to control said displacement, i.e. said first motion and said second motion.

The apparatus according to the present invention wherein the control device is adapted to control said first and/or second velocity.

The apparatus according to the present invention wherein the control device is adapted to control the motions of displacement, including said first and second motion, of said container section according to a predetermined pathway, which is expressed by the displacement x_{C}(t) as a function of time.

The apparatus according to the present invention wherein the apparatus and the actuating device are adapted to perform the motions of displacement, including said first and second motion, of said container section according to a predetermined pathway, which is expressed by the displacement x_{C}(t) as a function of time.

The apparatus according to the present invention wherein x_{C}(t) is a periodical function of time with the period T, the amplitude A and the frequency f_{C}.

The apparatus according to the present invention wherein x_{C}(t) is a non-sinusoidal periodic function.

The apparatus according to the present invention wherein x_{C}(t) is a sawtooth-like function.

The apparatus according to the present invention wherein x_{C}(t) is a sawtooth-like function, wherein the displacement x_{C}(t) within each period T comprises a first flank section of a first slope, which is an increasing slope, and a second flank section of a second slope, which is a decreasing slope, wherein said first slope corresponds to said first velocity of said container section and said second slope corresponds to said second velocity of said container section.

The apparatus according to the present invention wherein the absolute values of said first slope and said second slope are different and therefore the absolute values of said first velocity and said second velocity are different, resulting in a force acting upon said particles in the fluid, which is capable of inducing a motion of said particles in relation to said container section.

The apparatus according to the present invention wherein the absolute value of said second velocity is higher than the absolute value of said first velocity of the container section, resulting in a force acting upon said particles in the fluid, which is capable of inducing a motion of said particles in relation to said container section in the second direction.

The apparatus according to the present invention wherein the absolute value of said second velocity is lower than the absolute value of said first velocity of the container section, resulting in a force acting upon said particles in the fluid, which is capable of inducing a motion of said particles in relation to said container section in the first direction.

The apparatus according to the present invention wherein for the same predetermined frequency f_{C} and the same amplitude A, the motion of the particles can be increased by further reducing said lower velocity.

The apparatus according to the present invention wherein for the same predetermined frequency f_{C} and the same amplitude A, the motion of the particles can be increased by further increasing said higher velocity.

The apparatus according to the present invention wherein for the same amplitude A, the motion of the particles can be increased by increasing the frequency f_{C}.

The apparatus according to the present invention wherein for the same frequency f_{C}, the motion of the particles can be increased by increasing the amplitude A.

The apparatus according to the present invention wherein the actuating device is adapted such that the direction of displacement of the container section is variable and that the displacement of said container section is possible in more than one direction, whereby the direction of motion of said particles in the fluid can be controlled.

The apparatus according to the present invention wherein the actuating device is adapted such that the direction of displacement of said container section is variable in all directions in space, whereby the direction of motion of said particles in the fluid can be controlled.

The apparatus according to the present invention wherein it comprises a plurality of actuating devices, each being connected to said container section and adapted to contribute to said displacement process.

The apparatus according to the present invention wherein it comprises at least one connecting device, which connects said container section to said actuating device.

The apparatus according to the present invention wherein it comprises at least one contact section, which mediates the motion of the actuating device to the container section.

The apparatus according to the present invention wherein it is adapted to perform a displacement process, which increases or decreases the relative velocity x′ᵣₑₗ of particles in relation to said container section.

The apparatus according to the present invention wherein it is adapted to perform a displacement process, which zeroes the relative velocity x′ᵣₑₗ of particles in relation to said container section.

The apparatus according to the present invention wherein it is adapted to perform a displacement process, which inverts the relative velocity x′ᵣₑₗ of particles in relation to said container section, resulting in an inverted motion of said particles in relation to said container section.

The apparatus according to the present invention wherein it is adapted to control a displacement process such that it moves particles in relation to said container section on a predetermined pathway in space, in particular along an arbitrary pathway as a function of time.

The apparatus or the method according to the present invention wherein the displacement function x_{C}(t) and/or the displacement velocity function v_{C}(t) are determined such that during one of said first or consecutive (e.g. second) motion the particle's Reynolds number is closer to the Newton region (Reₚ>1000) than during the respective other motion.

The apparatus or the method according to the present invention wherein the displacement function x_{C}(t) and/or the displacement velocity function v_{C}(t) are preferably determined such that during said consecutive (e.g. second) motion the particle's Reynolds number is closer to the Newton region (Reₚ>1000) than during the first motion.

The apparatus according to the present invention wherein said container section comprises at least one first section and at least one second section, which is adjacent and connected to said first section, said first and second section being each adapted to hold at least one fluid containing initially a mix of at least two types of particles, wherein said mix comprises at least one first type of particles, e.g. related to a first Reynolds number, and at least one second type of particles, e.g. related to a second Reynolds number, which is different from said first Reynolds number, the apparatus being adapted to separate said mix of particles by performing a displacement process by means of said at least one actuating device, such that said first type of particles becomes concentrated in said first section and said second type of particles becomes concentrated in said second section.

The apparatus according to the present invention wherein said container section comprises at least one first section and at least one second section, which is adjacent and connected to said first section, said first and second section being adapted to hold at least one fluid containing at least two types of particles, i.e. at least one first type of particles, e.g. related to a first Reynolds number, and at least one second type of particles, e.g. related to a second Reynolds number, which is different from said first Reynolds number, said first section being adapted to initially hold particles in high concentration, the apparatus being adapted to mix said particles from said first section of high concentration into said second section by performing a displacement process by means of said at least one actuating device, such that said particles become distributed with a lower concentration in said first and second section.

Apparatus according to the present invention which is adapted to use a numerical solution of the equation of motion of a particle in a fluid in a repeatedly displaced container section.

Apparatus according to the present invention which is adapted to perform a shaking motion of said container section.

Apparatus for performing a shaking motion, wherein the displacement process comprises an impact like motion, which comprises a relative slow accelerated downward motion, which is finished with an abrupt stop of the motion.

Apparatus for performing a shaking motion, wherein the first motion is a downward motion with a relative slow first acceleration, ending at a certain first velocity of the container section, followed by an abrupt stop, and an upward motion, comprising a second acceleration which is higher than said first acceleration.

Apparatus for performing a shaking motion, wherein the displacement process preferably comprises a repetition of displacements, wherein, preferably for each displacement, the first motion from said first to said second position refers to a downward motion and the second motion from said second to said first position refers to an upward motion, and wherein the time period of said first motion is longer than the time period of said second motion.

Centrifuge, in particular for use in a laboratory, which is provided with an apparatus according to the present invention.

Apparatus, in particular laboratory apparatus, which is provided with an apparatus according to the present invention.

Automated system, in particular laboratory system for sample analysis or sample production, which is provided with an apparatus according to the present invention.

Use of an apparatus according to the present invention to separate particles in a fluid at Reynolds numbers larger than 0.5 from said fluid by moving said particles toward the bottom of a container, which is comprised by said container section.

Use of an apparatus according to the present invention to mix particles in a fluid at Reynolds numbers larger than 0.5, which are concentrated in at least one section of the fluid in said container section, by moving said particles into the fluid.

Use of an apparatus according to the present invention to sort particles in a fluid at different Reynolds numbers larger than 0.5, in particular according to the particle size or according to the specific particle weight, wherein said particles are concentrated in at least one section of the fluid in said container section, by moving said particles in the fluid to different distances.

Use of an apparatus according to the present invention to sort particles corresponding to different Reynolds numbers larger than 0.5 in a fluid, in particular according to the particle size or according to the specific particle weight, wherein said particles are concentrated in at least one section of the fluid in said container section, by moving said particles in the fluid to different distances.

Use of an apparatus according to the present invention for performing a shaking motion of a container section, which contains said fluid.

Computer code to calculate a numerical solution of the equation of motion of a particle in a fluid in a repeatedly displaced container section for use with the apparatus or method according to the present invention.

Computer code, i.e. computer program code, to control the displacement process; preferably a computer code to control the displacement process by means of a control device, in particular the control device of the apparatus according to the present invention; and preferably a computer code to control the displacements of the container section, in particular the container section of the apparatus according to the present invention, wherein the computer code preferably utilises a function x_{C}(t) or v_{C}(t), which respectively represent the motion of the container section over time.

Data storage medium to store data for operating the apparatus according to the present invention.

Other preferred features and advantages of the apparatus according to the present invention can be taken from the following description of methods according to the present invention, in particular those methods of operating the apparatus according to the present invention.

The present invention achieves the object of the invention further by providing a method for moving particles in a fluid at Reynolds numbers larger than 0.5, comprising the steps:

holding said fluid with said particles in a container section; having a at least one actuating device connected to said container section; performing a displacement process, which includes preferably a number of repeated displacements of said container section, by means of said actuating device; performing said displacement by performing a first motion of said container section from a first position to a second position and a second motion of said container section from said second position back to said first position by means of said actuating device, wherein during said first motion said container section is at least temporarily moved with a first velocity, and wherein during said second motion said container section is at least temporarily moved with a second velocity, which is different from said first velocity, applying a force by means of said displacement process upon said particles in the fluid, which is capable of inducing a directed motion of said particles in relation to said container section, wherein said first and second velocity of said container section control said motion of the particles.

Using the explanations and definitions of the description of the present invention, the following embodiments and uses of the method according to the present invention are provided:

Method according to the present invention wherein the direction of the motion of said particles is dependent on the directions of said first and second velocity.

Method according to the present invention wherein said force is capable of inducing a velocity x′ᵣₑₗ of said particles relative to said container section, wherein said force is dependent on x′ᵣₑₗ².

Method according to the present invention wherein it comprises the step of repetitive performing said displacement with periodical repetition according to a displacement frequency f_{C}.

Method according to the present invention wherein it comprises the step of using a control device.

Method according to the present invention wherein it comprises the step of controlling said displacement process by means of a control device.

Method according to the present invention wherein it comprises the step of controlling said displacement, i.e. said first motion and said second motion.

Method according to the present invention wherein it comprises the step of controlling said first and/or said second velocity.

Method according to the present invention wherein it comprises the step of controlling the motions of displacement, including said first and second motion, of said container section according to a predetermined pathway, which is expressed by the displacement x_{C}(t) as a function of time.

Method according to the present invention wherein it comprises the step of performing the motions of displacement, including said first and second motion, of said container section according to a predetermined pathway, which is expressed by the displacement x_{C}(t) as a function of time by means of said actuating device.

Method according to the present invention wherein x_{C}(t) is a periodical function of time with the period T, the amplitude A and the frequency f_{C}.

Method according to the present invention wherein x_{C}(t) is a non-sinusoidal periodic function.

Method according to the present invention wherein x_{C}(t) is a sawtooth-like function.

Method according to the present invention wherein x_{C}(t) is a sawtooth-like function, wherein the displacement x_{C}(t) within each period T comprises a first flank section of a first slope, which is an increasing slope, which means it increases in the direction of said first direction, and a second flank section of a second slope, which is a decreasing slope, wherein said first slope corresponds to said first velocity of said container section and said second slope corresponds to said second velocity of said container section.

Method according to the present invention wherein the absolute values of said first slope and said second slope are different and therefore the absolute values of said first velocity and said second velocity are different, resulting in a force acting upon said particles in the fluid, which is capable of inducing a motion of said particles in relation to said container section.

Method according to the present invention wherein the absolute value of said second velocity is higher than the absolute value of said first velocity of the container section, resulting in a force acting upon said particles in the fluid, which is capable of inducing a motion of said particles in relation to said container section in the second direction.

Method according to the present invention wherein the absolute value of said first velocity is higher than the absolute value of said second velocity of the container section, resulting in a force acting upon said particles in the fluid, which is capable of inducing a motion of said particles in relation to said container section in the first direction.

Method according to the present invention wherein for the same predetermined frequency f_{C} and the same amplitude A, the motion of the particles can be increased by further reducing said lower velocity.

Method according to the present invention wherein for the same predetermined frequency f_{C} and the same amplitude A, the motion of the particles can be increased by further increasing said higher velocity.

Method according to the present invention wherein for the same amplitude A, the motion of the particles can be increased by increasing the frequency f_{C}.

Method according to the present invention wherein for the same frequency f_{C}, the motion of the particles can be increased by increasing the amplitude A.

Method according to the present invention wherein it comprises the step of controlling the direction of motion of said particles in the fluid by an actuating device, which is adapted such that the direction of displacement of the container section is variable and that the displacement of said container section is possible in more than one direction.

Method according to the present invention wherein it comprises the step of controlling the direction of motion of said particles in the fluid by an actuating device, which is adapted such that the direction of displacement of said container section is variable in all directions in space.

Method according to the present invention wherein it comprises the step of letting at least one of a plurality of actuating devices, each being connected to said container section, at least partially control said displacement process.

Method according to the present invention wherein it comprises the step of performing a displacement process such that it increases or decreases the relative velocity x′ᵣₑₗ of particles in the fluid in relation to said container section.

Method according to the present invention wherein it comprises the step of performing a displacement process, which zeroes the relative velocity x′ᵣₑₗ of particles in the fluid in relation to said container section.

Method according to the present invention wherein it comprises the step of performing a displacement process, which inverts the relative velocity x′ᵣₑₗ of particles in relation to said container section, resulting in an inverted motion of said particles in relation to said container section.

Method according to the present invention wherein it comprises the step of controlling a displacement process such that it moves particles in relation to said container section on a predetermined pathway in space, in particular along an arbitrary pathway as a function of time.

Method according to the present invention wherein it comprises the steps of providing a container section with at least one first section and at least one second section, which is adjacent and connected to said first section, said first and second section being each adapted to hold at least one fluid containing initially a mix of at least two types of particles, wherein said mix comprises at least one first type of particle with a first Reynolds number, and at least one second type of particle with a second Reynolds number, which is different from said first Reynolds number, the apparatus being adapted to separate said mix of particles by performing a displacement process by means of said at least one actuating device, such that said first type of particles becomes concentrated in said first section and said second type of particles becomes concentrated in said second section.

Method according to the present invention wherein it comprises the steps of providing a container section with at least one first section and at least one second section, which is adjacent and connected to said first section, said first and second section being adapted to hold at least one fluid containing at least two types of particles, i.e. at least one first type of particle with a first Reynolds number, and at least one second type of particle with a second Reynolds number, which is different from said first Reynolds number, said first section being adapted to initially hold particles in high concentration, the apparatus being adapted to mix said particles from said first section of high concentration into said second section by performing a displacement process by means of said at least one actuating device, such that said particles become distributed with a lower concentration in said first and second section.

Method according to the present invention which uses a numerical solution of the equation of motion of a particle in a fluid in a repeatedly displaced container section.

Preferably, said methods are applied by using the apparatus according to the invention.

Further advantages, features and applications of the present invention can be derived from the following embodiments of the apparatus and the methods according to the present invention with reference to the drawings. In the following, equal reference signs substantially describe equal devices.

FIG. 1 shows a schematic drawing of the forces, which act upon a particle in a fluid, for illustrating the technical background of the invention.

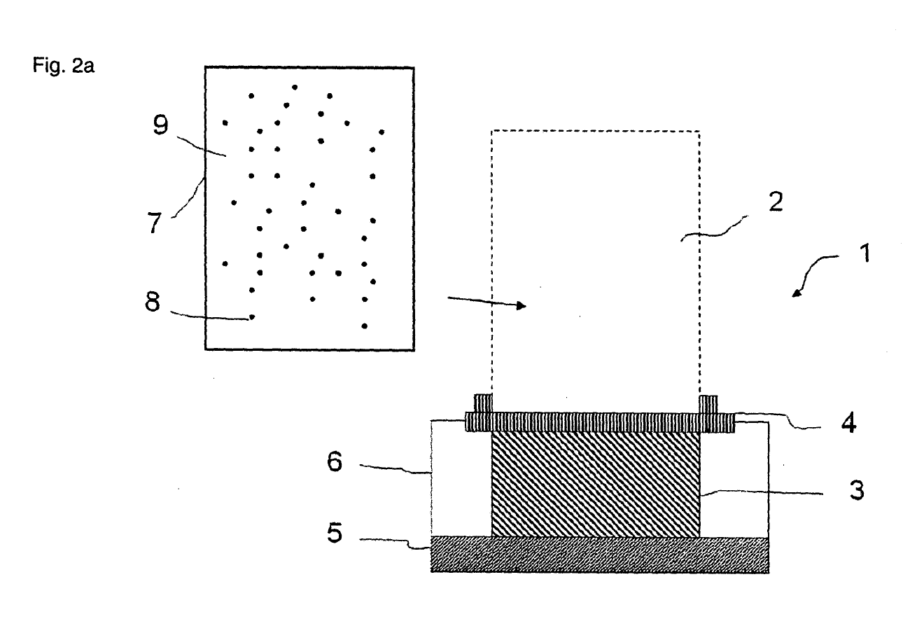

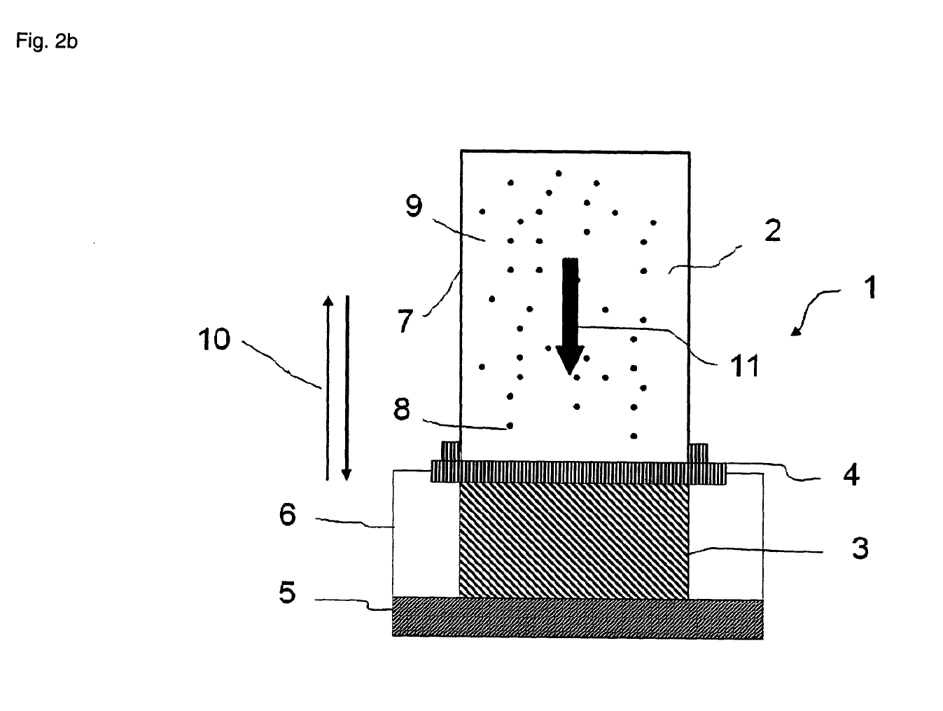

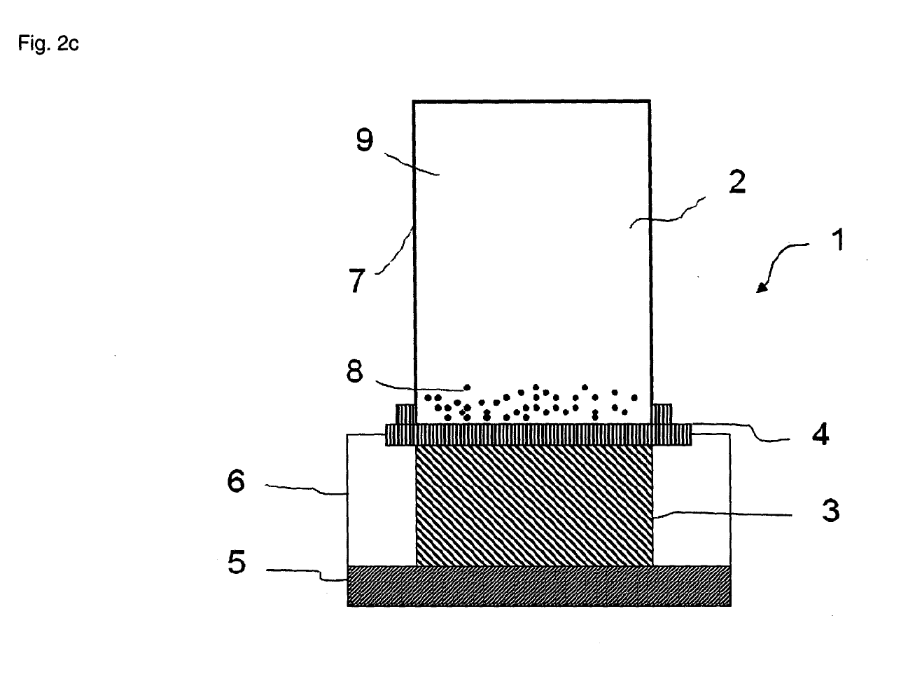

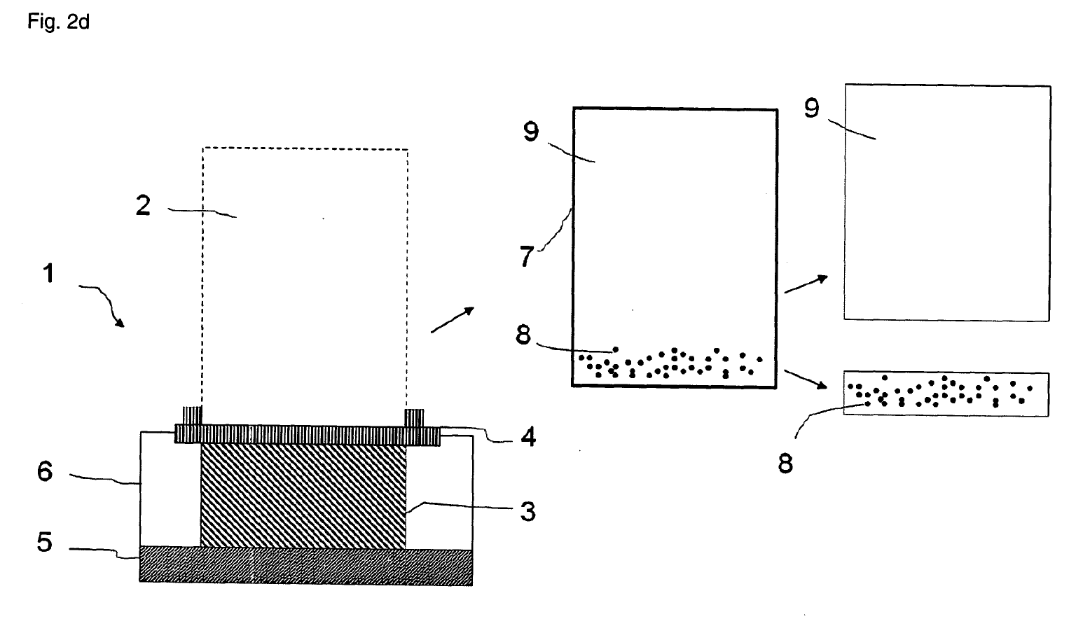

FIG. 2a shows a schematic drawing of an embodiment of the apparatus 1 according to the present invention.

FIG. 2b shows a schematic drawing of an embodiment of the apparatus 1 according to the present invention.

FIG. 2c shows a schematic drawing of an embodiment of the apparatus 1 according to the present invention.

FIG. 2d shows a schematic drawing of an embodiment of the apparatus 1 according to the present invention.

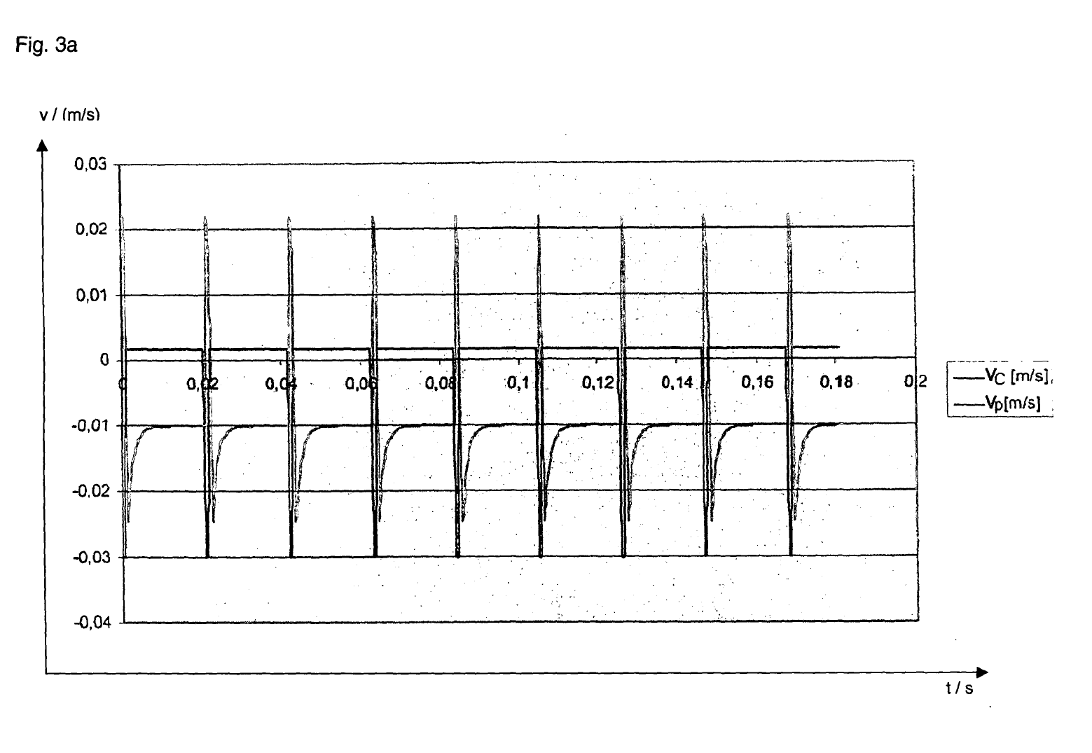

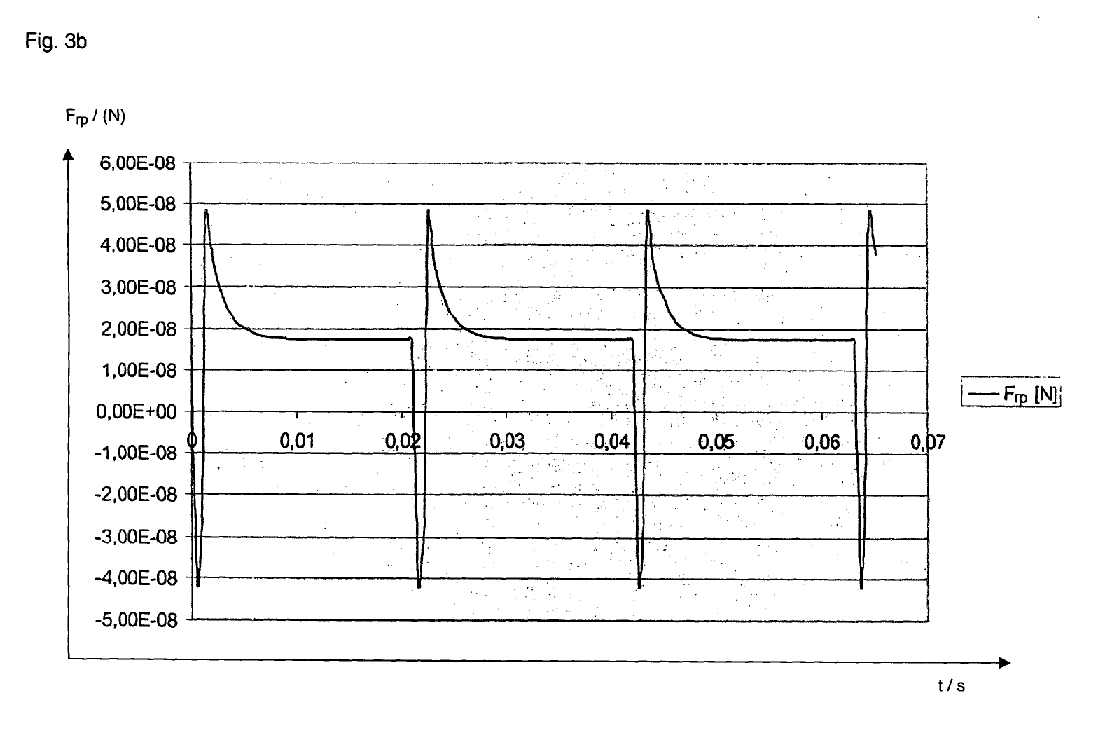

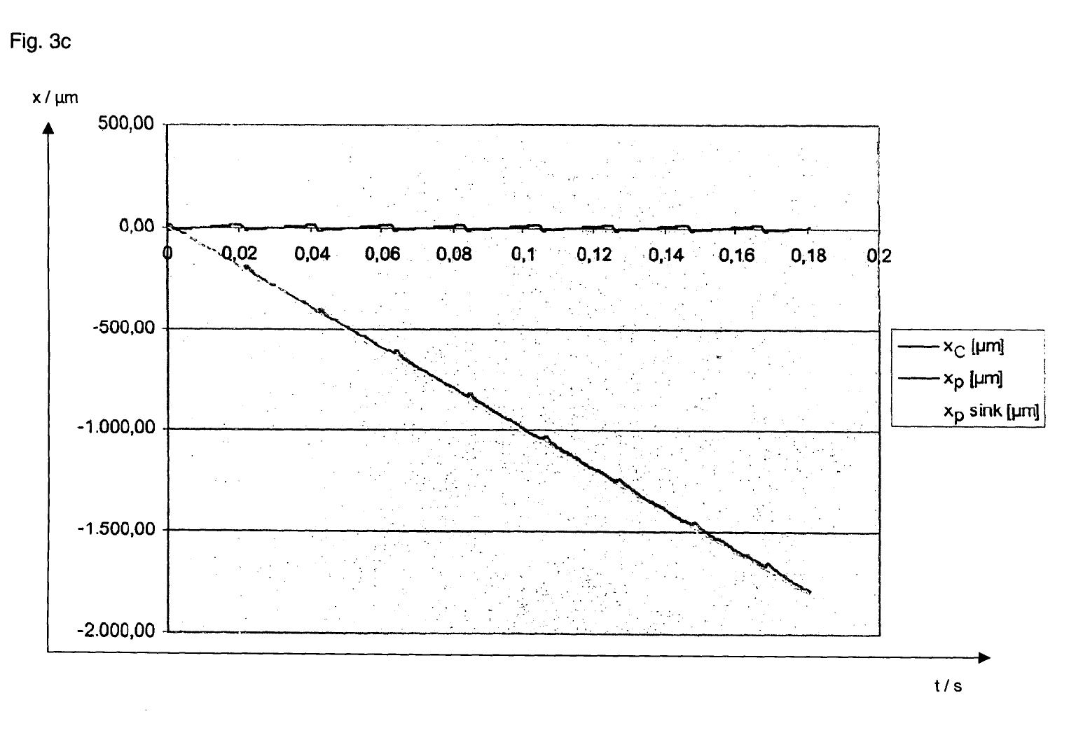

FIG. 3a shows a diagram with the temporal course of a saw-tooth-like displacement x_{C} of an embodiment of the apparatus according to the present invention with resulting square-shaped velocity v_{C} and the particle velocity vₚ in m/s with a maximum Reynolds number Remax=3.62 of the particles in a liquid, f_{C}=47.62 Hz, diameter of the particles Dₚ=150 μm and amplitude A=+−15 μm, where the parameters are not chosen appropriate to induce a directed motion of the particles in the fluid, apart from sedimentation.

FIG. 3b shows a diagram with the force due to the fluid-dynamic resistance Fᵣₚ as an answer on a saw-tooth-like displacement of FIG. 3a of an embodiment of the apparatus according to the present invention, wherein Reₘₐₓ=3.62, f_{C}=47.62 Hz, Dₚ=150 μm and A=+−15 μm.

FIG. 3c shows a diagram of the temporal course of the pathway xᵣₑₗ of sedimentation of a particle due to Stokes drift in a displaced container section of an embodiment of the apparatus according to the present invention having a displacement according to FIG. 3a, wherein Reₘₐₓ=3.62, f_{C}=47.62 Hz, Dₚ=150 μm and A=+−15 μm.

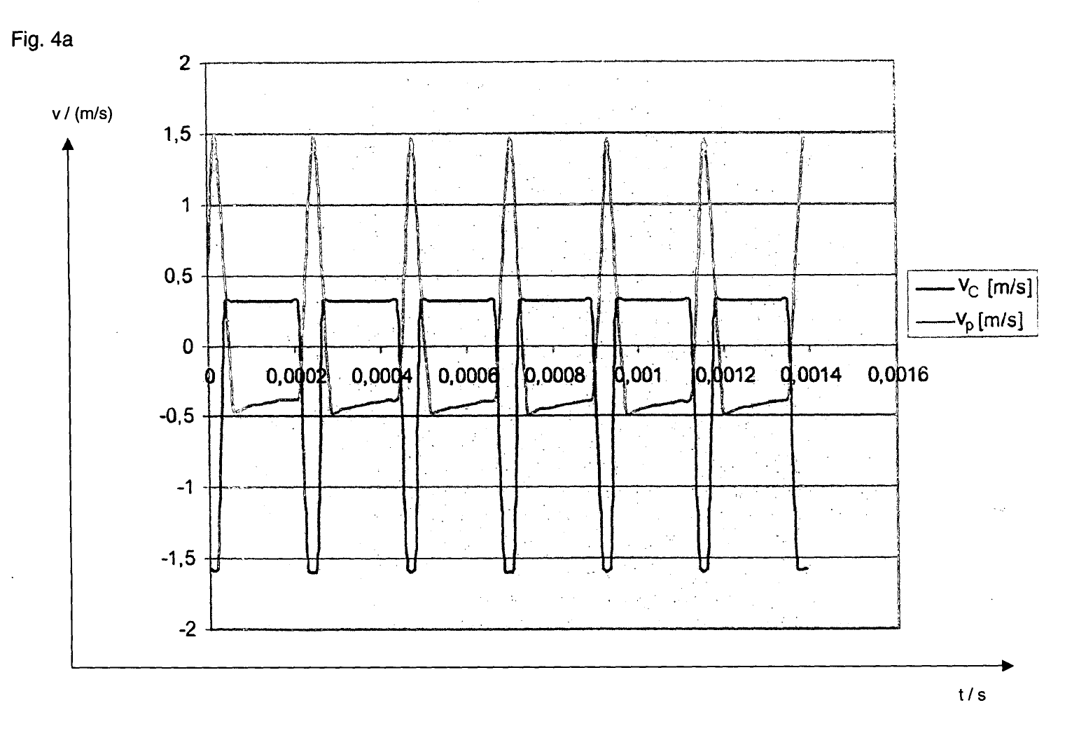

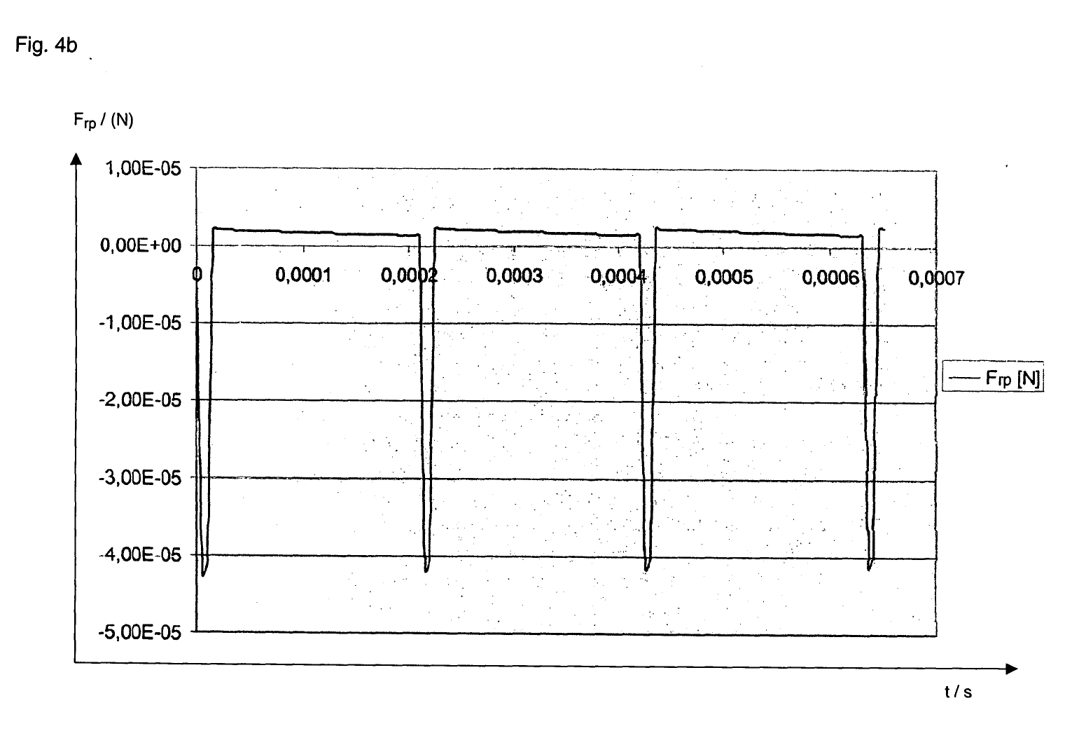

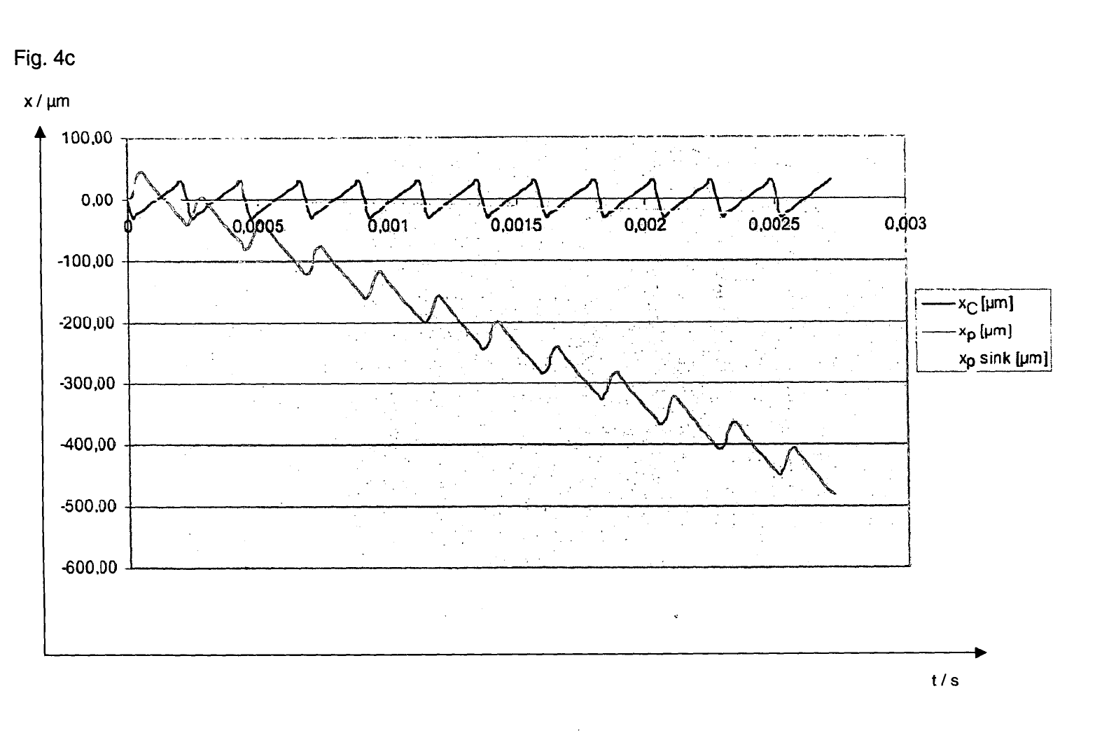

FIG. 4a shows a diagram with the temporal course of a saw-tooth-like displacement of an embodiment of the apparatus or method according to the present invention with velocity v_{C} in m/s and the particle velocity vₚ in m/s, wherein Reₘₐₓ=218, f_{C}=4386 Hz, Dₚ=150 μm and A=+−30 μm, where the parameters are chosen appropriate to induce a directed motion of the particles in the fluid, in addition to sedimentation.

FIG. 4b shows a diagram with the force due to the fluid-dynamic resistance Fᵣₚ as an answer on a saw-tooth-like displacement of FIG. 4a of an embodiment of the apparatus or method according to the present invention, wherein Reₘₐₓ=218, f_{C}=4386 Hz, Dₚ=150 μm and A=+−30 μm.

FIG. 4c shows a diagram of the temporal course of the pathway xrel of sinking of a particle due to the displacement process in a displaced container section of an embodiment of the apparatus or method according to the present invention, wherein Reₘₐₓ=218, f_{C}=4368 Hz, Dₚ=150 μm and A=+−30 μm.

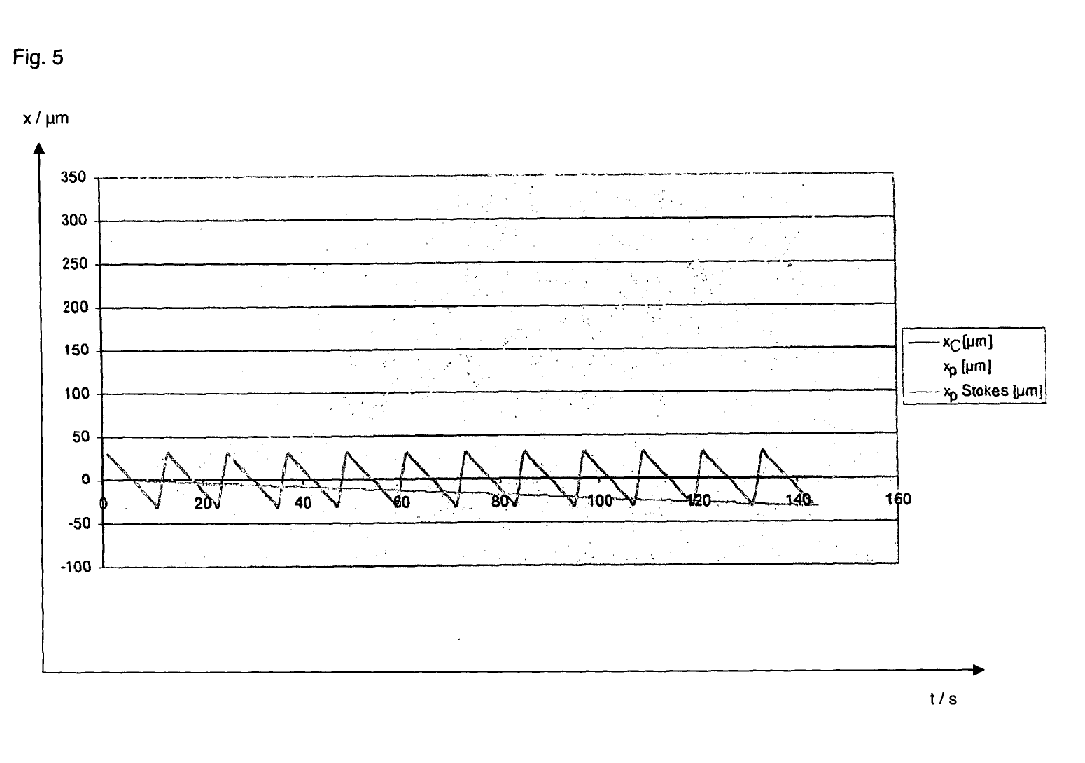

FIG. 5 shows a diagram of the temporal course of the pathway xᵣₑₗ of ascension of a particle due to the displacement process in a displaced container section of an embodiment of the apparatus or method according to the present invention, wherein Reₘₐₓ=218, f_{C}=4368 Hz, Dₚ=150 μm and A=+−30 μm.

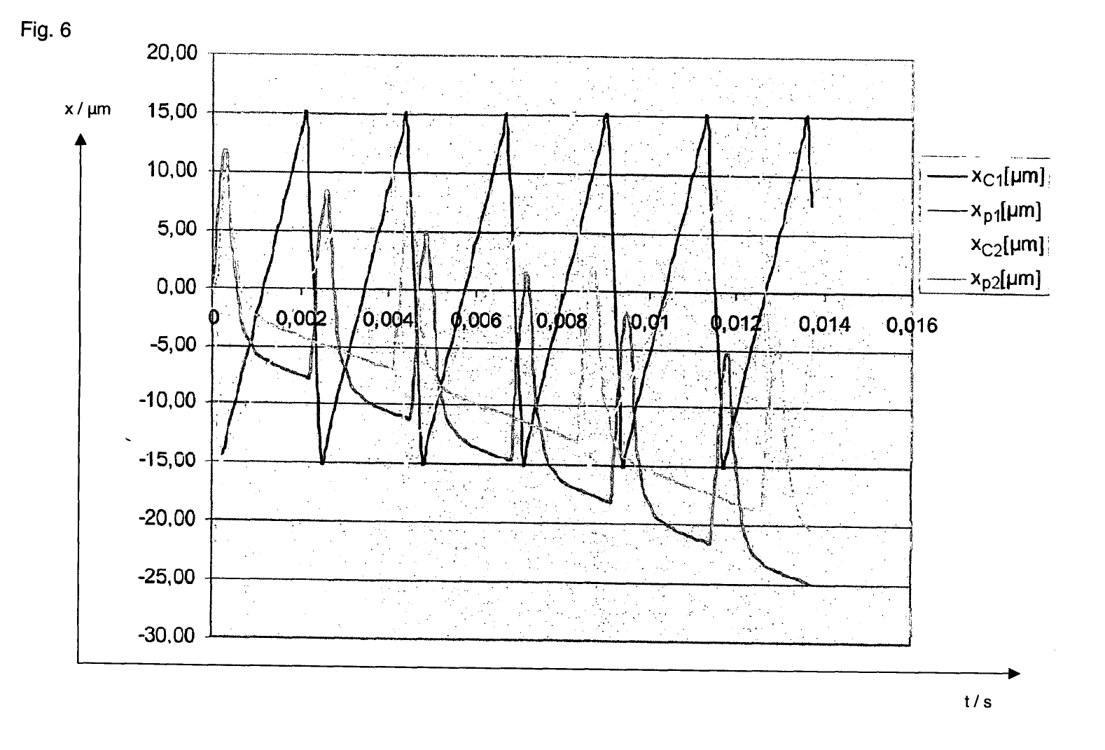

FIG. 6 shows a diagram of the temporal course of the pathway xᵣₑₗ of sinking of a particle due to the displacement process in a displaced container section of an embodiment of the apparatus or method according to the present invention in dependence on the frequency f_{C}, wherein Reₘₐₓ=218, f_{C1}=434 Hz, f_{C2}=236.74 Hz, Dₚ=50 μm and A=+−15 μm.

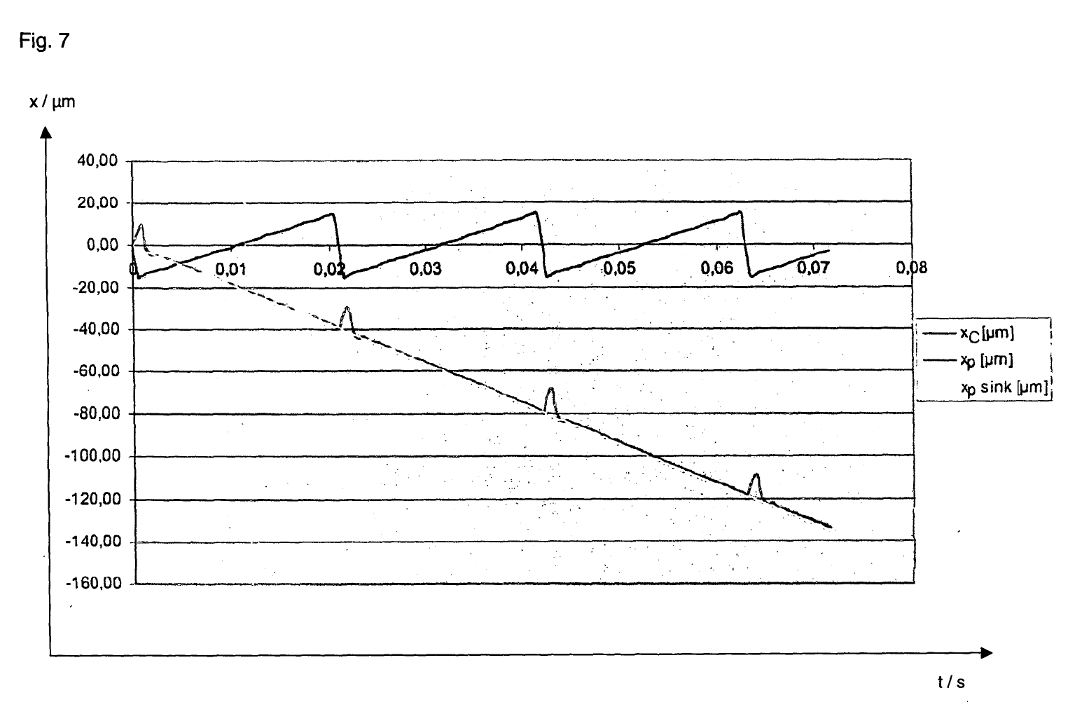

FIG. 7 shows another diagram of the temporal course of the pathway xᵣₑₗ of sedimentation of a particle due to Stokes drift in a displaced container section of an embodiment of the apparatus according to the present invention, wherein Reₘₐₓ=1.78, f_{C}=47.62 Hz, Dₚ=60 μm and A=+−15 μm.

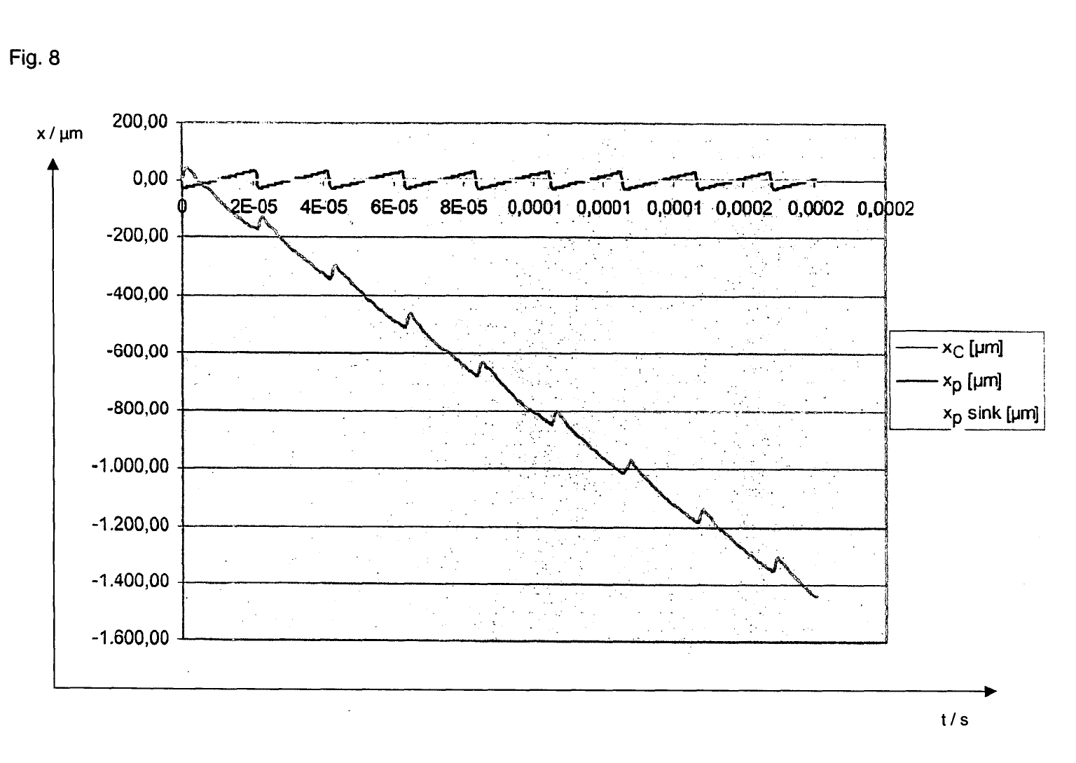

FIG. 8 shows a diagram of the temporal course of the pathway xᵣₑₗ of sinking of a particle due to the displacement process in a displaced container section of an embodiment of the apparatus or method according to the present invention, wherein Reₘₐₓ=218, f_{C}=4368 Hz, Dₚ=150 μm and A=+−15 μm.

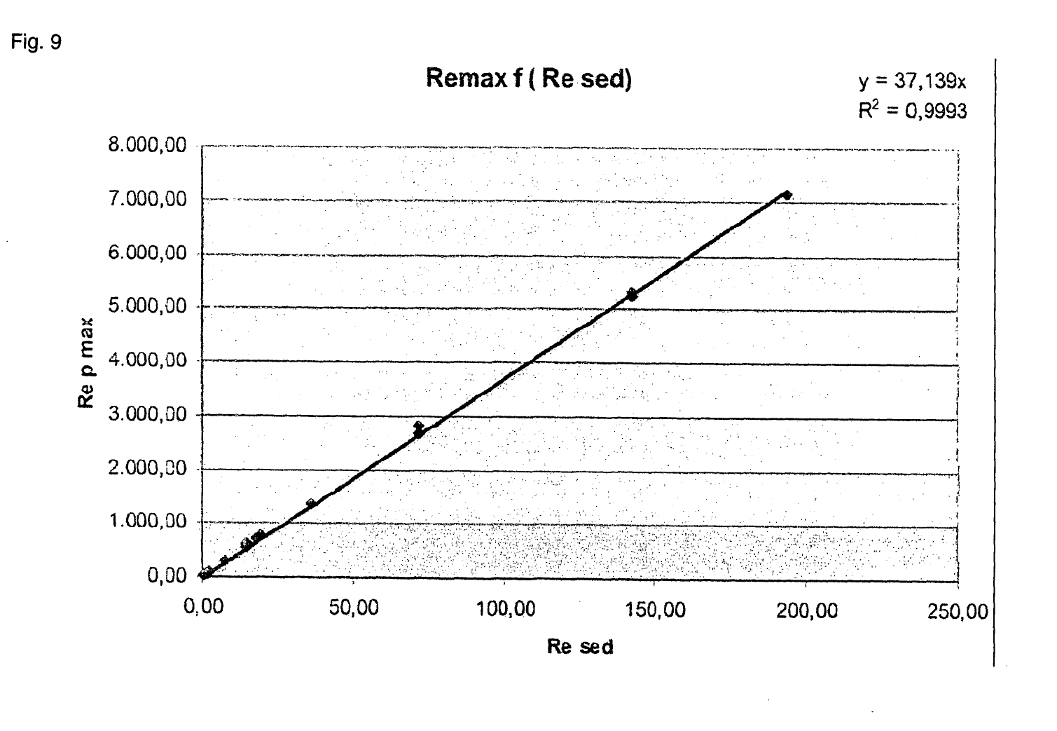

FIG. 9 shows a diagram with the progression of the maximum particle Reynolds number, which is used exemplarily in the apparatus and the method according to the present invention, in dependence on the maximum Reynolds number of sedimentation in a fluid.

FIG. 10 shows examples a), b) and c) of possible types of motions x_{C}(t) of the container section, as described above.

FIG. 11 shows another possible type of motion x_{C}(t) of the container section, as described above.

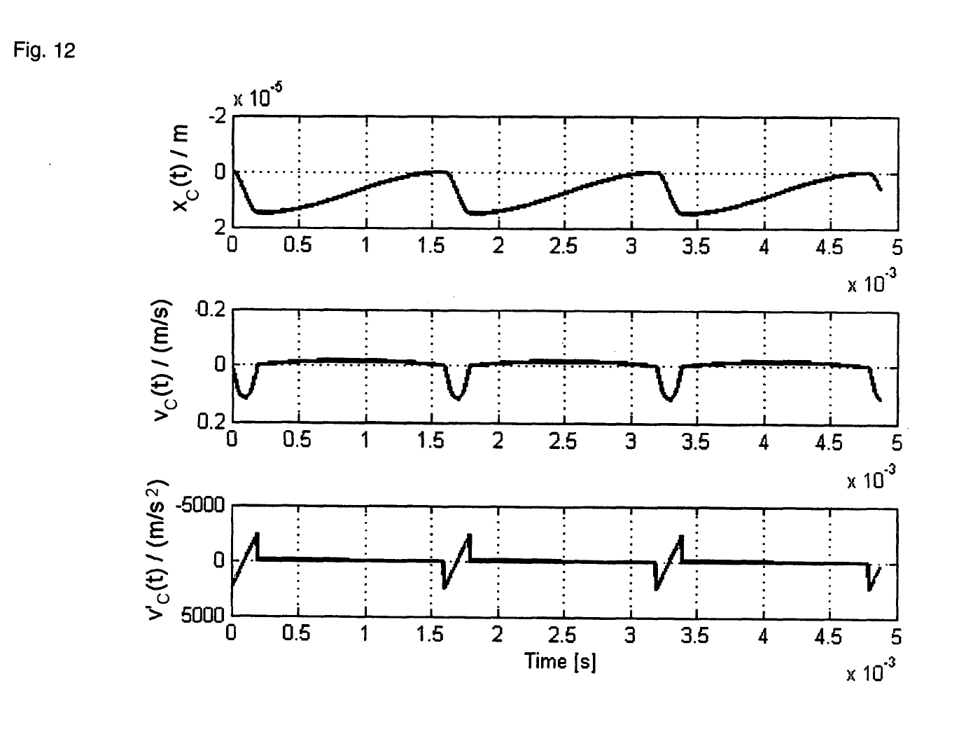

FIG. 12 is a diagram with three curves, which represent the position x_{C}(t), the corresponding velocity v_{C}(t) and the corresponding acceleration v′_{C}(t) of a moved container section containing particles in water, which was periodically displaced by means of an embodiment of the apparatus and method according to the present invention.

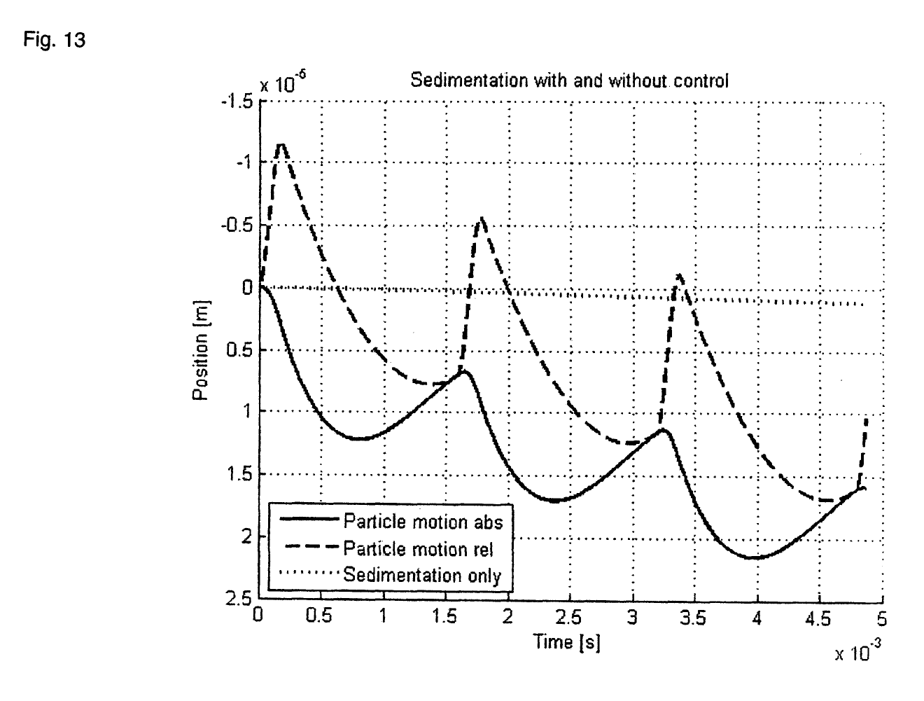

FIG. 13 is a diagram, which shows the particle motion of the particles in water corresponding to FIG. 12, as induced by the embodiment of the apparatus and method according to the present invention of FIG. 12.

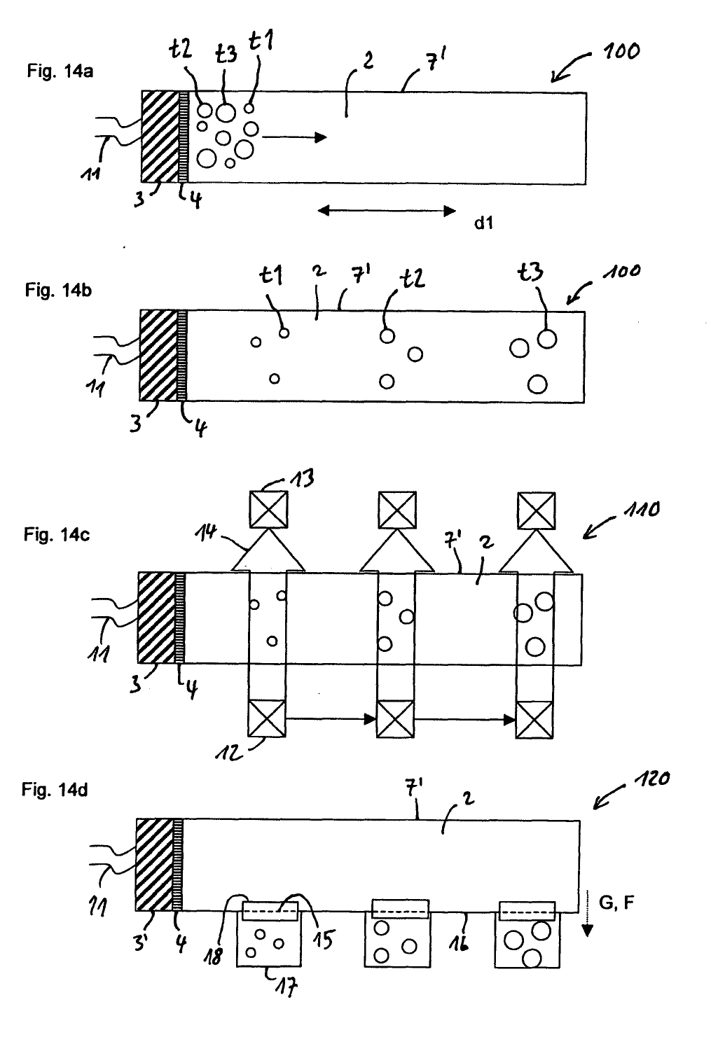

FIG. 14a shows an embodiment of a sorting device according to the present invention which implements the apparatus according to the present invention, in a starting position of particles with different sizes.

FIG. 14b shows the sorting device of FIG. 14a with the particles, which are distributed along the direction d1 according to their size.

FIG. 14c shows an embodiment of an detection device according to the present invention, implementing the sorting device of FIG. 14a/b.

FIG. 14d shows an alternative embodiment of a sorting device according to the present invention which implements the apparatus according to the present invention, which allows to recover the sorted particles from the fluid by moving them down to receptacles at the containers bottom by gravity G or induced force F.

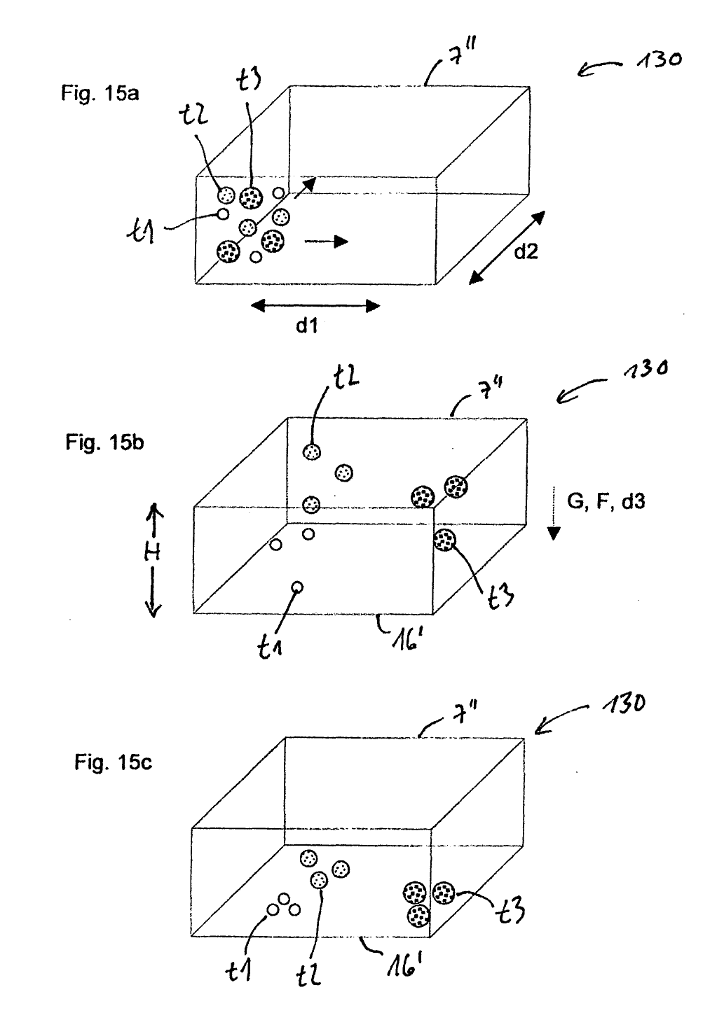

FIG. 15a shows another embodiment of a sorting device according to the present invention which implements the apparatus according to the present invention, in a starting position of particles with different sizes.

FIG. 15b shows the sorting device of FIG. 15a with the sorted particles, which are distributed in the plane defined by the directions d₁ and d₂.

FIG. 15c shows the sorting device of FIG. 15a with the sorted particles, which are distributed in the plane defined by the directions d₁ and d₂ and which are further moved down to the containers bottom by gravity G or induced force F.

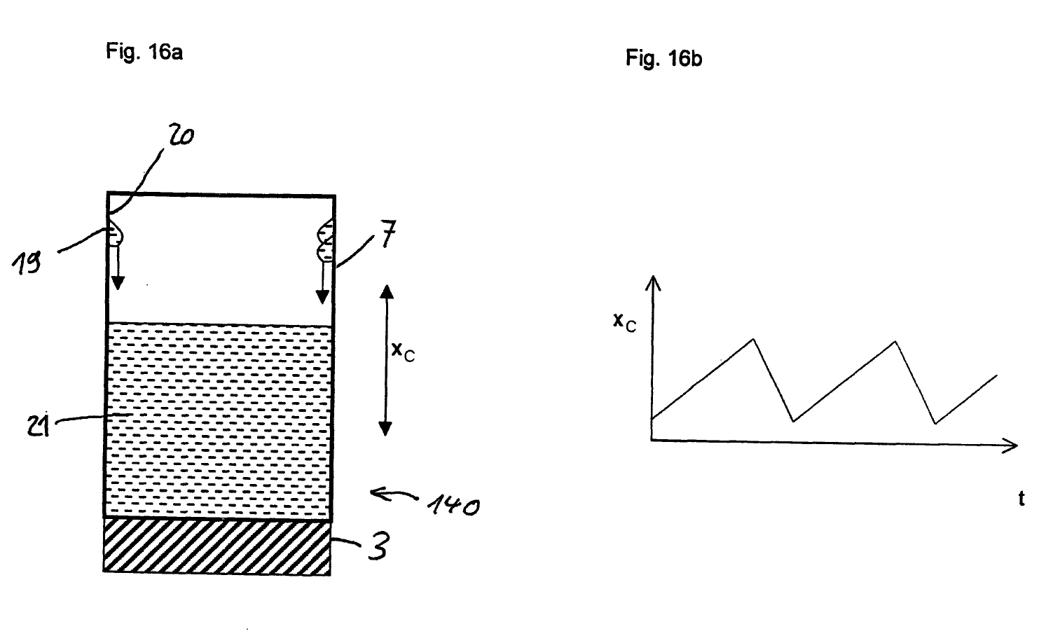

FIG. 16a shows another embodiment of the apparatus according to the present invention, adapted to perform a shaking motion to shake off liquid drops, which adhere at the wall of the container, by means of a repeated displacement x_{C} of the container.

FIG. 16b shows a graph with an example for an appropriate displacement x_{C} of FIG. 16a as a function of time.

FIGS. 2a to 2d show schematically the use of an apparatus 1 according to an embodiment of the present invention to separate particles 8 with Reynolds numbers larger than 0.5, which are contained in a fluid 9, from said fluid.

FIG. 2a shows a schematic drawing of an embodiment of the apparatus 1 according to the present invention. The apparatus provides a housing 6, a container section 2, a piezo element 3, which is the actuating device, firmly connected to the solid stand 5 of the apparatus and which is capable of actuating the container section 2 in a displacement process. The container section is just a volume in space in this embodiment, which is adapted to hold the fluid, in particular by holding the container 7. The container 7 holds a fluid 9, which is a liquid here, which contains particles 8, which are moved in particular at Reynolds numbers larger than 0.5.

In FIG. 2b, the container 7 is placed into the container section 2 and is now regarded as a part of the container section 2. The container section 2, comprising the container 7, which contains the liquid 9, is firmly connected to the actuating device 3 by the connecting device 4, which is a plate with clamps to hold the container section 2 with the container 7. In FIG. 2b, the apparatus performs a displacement process on the container section, containing the container 7 with the fluid 9 and the particles 8. The displacement x_{C}(t) is an up- and down motion 10 of the container section, which comprises the first motion from the first position, which is the lowest position, into the second position, which is the highest position, and the second motion from the second position back to the first position. The first and second position are reached by a linear motion, which means that the displacement is one-dimensional. The displacement has an amplitude A, a frequency f_{C} and a first velocity in the upward direction, which is smaller than the second velocity in the downward direction. As a consequence, the waveform of the resulting function x_{C}(t) is saw-tooth-like, with an increasing first slope in each period and a decreasing second slope. The fluid-dynamic resistance Fᵣₚ, which is proportional to the square of the particle velocity x′ᵣₑₗ (also ‘vₚ’) for the particles 8 and the liquid 9, is higher for the second motion (downward) than for the first motion (upward), which causes a force to act upon the particles 8 in the liquid 9. The force causes a directed motion of the particles 8 in the liquid in relation to the container section 2. After the separation time tₐ, the particles are separated to the bottom of the container, which is shown in FIG. 2c, and the displacement process is stopped. Now, as shown in FIG. 2d, the particles can easily be separated from the container. It can be seen that from the position of the particles in FIG. 2c, that a force, which acts upward upon the particles, would cause an upward motion, which transports the particles back into the liquid 9. This can be achieved by using an x_{C}(t), which provides a saw-tooth-like displacement with a first velocity upward, which is higher than the second velocity downward.

FIG. 3a shows a diagram with the temporal course of a saw-tooth-like displacement with velocity v_{C} and the particle velocity vₚ in m/s with a maximum Reynolds number Reₘₐₓ=3.62 of the particles in a liquid, f_{C}=47.62 Hz, diameter of the particles Dₚ=150 μm and amplitude A=+−15 μm. The maximum Reynolds number Reₘₐₓ of a defined particle in a fluid during a periodical displacement process, which acts on said fluid, is the Reynolds number of said particle at its maximum velocity vᵣₑₗ relative to the container section within one period of said displacement process x_{C}. In this example, the particle shows a symmetrical oscillation on the saw-tooth-like displacement. The velocities of the particle are moving it almost equivalent upward and downward, superimposed by the common Stokes drift velocity, which lets the particles sink with a constant velocity in the fluid due to Fₚ, Fₐ and Fₘ (see above). In correspondence, the integral of the force on the particle due to the fluid dynamic resistance is equivalent in each direction, as can be seen in FIG. 3b. FIG. 3b shows a diagram with the force due to the fluid-dynamic resistance Fᵣₚ as an answer on a saw-tooth-like displacement, wherein Reₘₐₓ≦3.62, f_{C}=47.62 Hz, Dₚ=150 μm and A=+−15 μm. At this relatively low Reynolds number Reₘₐₓ, the velocity vₚ cannot shown to be different in dependence on the displacement process according to FIG. 3a, within the limits of accuracy, as can be seen in FIG. 3c. FIG. 3c shows a diagram of the temporal course of the pathway xᵣₑₗ of sedimentation of a particle due to Stokes drift in a displaced container section, wherein Reₘₐₓ=3.62, f_{C}=47.62 Hz, Dₚ=150 μm and A=+−15 μm.

The behaviour of the particle changes remarkably when the Reynolds number is increasing, as shown in FIG. 4a, demonstrated at a higher frequency of displacement f_{C}=4386 Hz. FIG. 4a shows a diagram with the temporal course of a saw-tooth-like displacement with velocity v_{C} and the particle velocity vₚ in m/s, wherein Reₘₐₓ=218, f_{C}=4386 Hz, Dₚ=150 μm and A=+−30 μm. The displacement velocity v_{C} induces a higher velocity vₚ in the upward direction than in the downward direction, which are therefore attenuated stronger by the higher (square) fluid-dynamic resistance Fᵣₚ than the velocities in the downward direction, as can be seen in FIG. 4b. FIG. 4b shows a diagram with the force due to the fluid-dynamic resistance Fᵣₚ as an answer on a saw-tooth-like displacement, wherein Reₘₐₓ=218, f_{C}=4386 Hz, Dₚ=150 μm and A=+−30 μm. As a consequence, the upward motions of the particle, which are induced over time by the oscillations, are stronger attenuated than the downward motions of the particle. This means, that the particle with an applied displacement process sinks faster than without displacement process, as can be seen in FIG. 4c. FIG. 4c shows a diagram of the temporal devolution of the pathway xᵣₑₗ of sinking of a particle due to the displacement process in a displaced container section, wherein Reₘₐₓ=218, f_{C}=4368 Hz, Dₚ=150 μm and A=+−30 μm. In this particular embodiment, the sinking velocity is 17.8 times higher than the Stokes drift velocity of the particle in the liquid. This means further that the system shows under a symmetric displacement in dependence on the frequency f_{C} already a strongly asymmetric answer of the particle motion.

FIG. 5 shows a diagram of the temporal course of the pathway xᵣₑₗ of ascension of a particle due to the displacement process in a displaced container section, wherein Reₘₐₓ=218, f_{C}=4368 Hz, Dₚ=150 μm and A=+−30 μm. The difference to the displacement process in FIGS. 4a to 4c is that the first and second velocities within one period of the saw-tooth-like function x_{C}(t) are exchanged, which means that the first velocity is higher than the second velocity. As a consequence, the force, which acts on the particle due to the fluid-dynamic resistance Fᵣₚ, is directed upwards and drives the particle upwards. By this kind of displacement, an inverting of the transport direction can be reached, which in the present embodiment drives the particles back to the solution, which can be used as the basis for an effective mixing of the particles into the fluid.

It can be further recognized from FIGS. 4a to 4c and FIG. 5 that a downward motion of the particle is not reached by the mass forces of the moved container, e.g. by a fictional strong impact in the +x direction, but rather by a preferably long and even motion of the container in the +x direction. To return to the first position, a preferably fast second motion is required, which is the more attenuated by the fluid-dynamic resistance Fᵣₚ, the faster it is. It can be further seen from the vₚ(t) diagrams that the integral ∫vₚ is not zero due to the fluid-dynamic resistance Fᵣₚ. Therefore, a force vector acts upon the particle, which can become as large as the force due to common centrifugation.

FIG. 6 shows a diagram of the temporal course of the pathway xᵣₑₗ of sinking of a particle due to the displacement process in a displaced container section in dependence on the frequency f_{C}, wherein Reₘₐₓ=218, f_{C1}=434 Hz, f_{C2}=236.74 Hz, Dₚ=50 μm and A=+−15 μm. Thus, the saw-tooth-like displacement x_{C}(t) is varied in the frequency, wherein the first velocity of the container, i.e. the first slope (increasing) is smaller for a smaller frequency, while the amplitude A and the second velocity (decreasing, second slope) is not varied. As can be seen, the curve x_{C1} of the displacement with higher frequency provides a slightly higher sinking velocity vₚ₁=dxₚ₁/dt than the curve x_{C2} of the displacement with smaller frequency with induced motion vₚ₂=dxₚ₂/dt. In a similar experiment, the frequencies are kept constant at 434 Hz, the amplitudes are kept constant at +−15 μm and the first slope is smaller in the first displacement curve v_{C} than in the second displacement curve v_{C}. As result, the sinking velocity vₚ due to a displacement x_{C} with smaller first slope is higher than the sinking velocity vₚ due to a displacement x_{C} with higher first slope. In consequence, for the same frequency f_{C} and amplitude A, a smaller first slope can increase the sinking velocity vₚ.

In contrast, making the (absolute value of the) second slope (decreasing slope) smaller can result in a slower sinking velocity vₚ. Therefore, making the (absolute value of the) second slope higher, can result in a remarkable increase of vₚ. Determining such a high second velocity, the sinking velocity vₚ can further be increased remarkably by increasing the frequency f_{C}, e.g. from 450 Hz to 4578 Hz leading to an improvement of vₚ by the factor 143. Doubling further the amplitude A, from +−15 μm to +−30 μm, can exemplarily increase the velocity vₚ by the factor 300, wherein Reₘₐₓ=246 in this example. It is clear from this results, that there is s wide scope of possibilities to increase and optimize the velocity vₚ, in particular by using other waveforms for x_{C}, which do not have to be linear functions, i.e. saw-tooth functions with constant first and second slopes as shown above, and can at least partially be non-linear shaped.

FIG. 7 shows another diagram of the temporal course of the pathway xₚ of sedimentation of a particle due to Stokes drift in a displaced container section, wherein Reₘₐₓ=1.78, f_{C}=47.62 Hz, Dₚ=60 μm and A=+−15 μm. As can be seen, also in this example a displacement process does not result in a detectable deviation of xₚ (xᵣₑₗ) from the sedimentation x_{p sink} of a particle due to Stokes drift. However, this changes remarkably with varying particle diameters Dₚ, displacement frequencies f_{C}, amplitudes A and fluid properties, e.g. μₗ. If for example the displacement frequency of FIG. 7 is increased to f_{C}=47619 Hz, the sinking velocity is increased by a factor of 1610, as can be seen in FIG. 8.

FIG. 8 shows a diagram of the temporal course of the pathway xᵣₑₗ of sinking of a particle due to the displacement process in a displaced container section, wherein Reₘₐₓ=218, f_{C}=4368 Hz, Dₚ=150 μm and A=+−15 μm. Further, a doubling of the amplitude in the example of FIG. 7 results in an increase of the sinking velocity by a factor of 4097. Reducing the particle diameter and increasing the kinematic viscosity v=μ/ρ, wherein μ is the dynamic viscosity and ρ is the density of the fluid ρₗ, does also increase the velocity vₚ by a factor. For example, changing to μ/ρ=400 and ρ=950 kg/m³ of engine lubricating oil results in a factor of 12230.

At least in the case of a saw-tooth-like function x_{C}(t), the maximum particle Reynolds number can be estimated from the Reynolds number of sedimentation in a fluid, as follows. Physically, there is an increase of the influence of the fluid-dynamic resistance Fᵣₚ with increasing Reynolds number. There is no influence for Reynolds numbers <0.5 (Stokes region), but the influence increases if Reₘₐₓ becomes larger than 0.5. Since it is not possible to determine Reₘₐₓ others than by calculation, there is defined an additional Reynolds number for sedimentation Re_{sed}=A*f_{C}*Dₚ/(μ/ρₗ). As can be seen in FIG. 9, the Reynolds number Re_{sed} correlates well with the maximum Reynolds number during one period of x_{C} of the particle. Thus, the maximum Reynolds number of a particle, which is in particular moved according the shown waveform, can be estimated by Reₘₐₓₚ=Re_{sed}*constant, wherein at the example of FIG. 9 said constant=37.139. From this formula, a condition for an improved sinking velocity vₚ can be expressed for aqueous liquids as f_{C}(Hz)>1.3463*10⁸/(Dₚ*A). Thus it can be derived from those formulas that for blood (μ/ρ=2*10⁶ m²/s, Dₚ=8 μm) at an amplitude A=+−15 μm a separation effect, i.e. improved sinking velocity, could already be expected at f_{c}>=224 Hz. It is even possible to move virus an comparable small particles in an aqueous solution with an amplitude of A=15 μm at frequencies f_{C}>=180 kHz.

Referring to the embodiment of FIGS. 12 and 13: In a real experiment, polystyrene particles of 100 μm diameter were placed at 20° room temperature in plastic “Eppendorf” re-action vessels with a vessel height of about 40 mm and an outer diameter of about 10 mm. Said vessels contained 2 ml of distilled water, which is the container section for the particles. Said vessels were fixed to a piezoelectric actor, which was capable of performing the required displacement process. The electromechanical actuator was provided with a stand, which was fixed to the ground. The applied motion of the container was a periodical saw-tooth-like function, as shown as the first graph in FIG. 12. The corresponding velocity profile v_{C}(t) and acceleration function are shown in the second and third graph of FIG. 12. The displacement frequency f_{C} was f_{C}=620 Hz, the amplitude A of the periodical displacement x_{C}(t) was 16 μm. Other preferred parameters for the described setup were provided by the ranges f_{C}=(620+−10) Hz, f_{C}=(780+−10) Hz and 12 μm<A<25 μm (amplitude A). The motion of the particles in the water, with and without displacement process, was filmed and evaluated.

FIG. 13 shows the motion xᵣₑₗ of the particles relative to the container (“Particle motion abs”), as calculated by equation 1, the motion of the particles without the effect of gravity (“Particle motion rel”) and the calculated sedimentation as effected by gravity. The experimental data, as evaluated, and the calculated data were in good agreement.

For the embodiment of the apparatus and method according to the present invention according to FIG. 12 and FIG. 13, the maximal Reynold numbers are Re₁=1.2 for the first motion moving upwards, where the velocity v_{C}(t) has rather low values, and Re₂=8.8 for the second motion moving downwards, where the velocity v_{C}(t) has relative high values. During the second motion, the fluid-dynamic resistance Fᵣₚ was more non-linear than during the first motion. Correspondingly, Re₁ was closer to the Stokes-region than Re₂. Due to the difference of non-linearity in Fᵣₚ, a motion xᵣₑₗ of the particles relative to the container was induced, which increased the absolute sedimentation of the particles by a factor of about 10, if compared with the sedimentation due to gravity.

FIG. 14a shows an embodiment of a sorting device 100 according to the present invention which implements the apparatus according to the present invention, in a starting position of particles t₁, t₂ and t₃ with different sizes in a liquid, which is contained in the container section 2 and encased by the container 7′. Of course, other numbers than three types of particles can be applied. The sorting device 100 comprises a piezo-actuator 3, which is controlled by a control device (not shown) via electrical connecting means 11. A connecting device 4 provides a removable fixed connection of the container 7′ to the piezo 3. The sorting device is adapted to perform a displacement process, wherein the container 7′ is repeatedly displaced along the direction d₁. A displacement comprises a motion forth and back along the direction d1 with different velocities of the forward- and backward-motion. According to the principles of inducing a force on particles in a fluid, as explained with the present invention, a force is induced which moved the particles along the direction d₁ to the right.

FIG. 14b shows the sorting device of FIG. 14a with the particles t₁, t₂ and t₃, which are distributed along the direction d₁ according to their different size, after having performed a displacement process for a time. The container 7′ is also a distribution section, which allows to distribute the particles along the direction d1 over an appropriate distance, which is limited by the length of the container 7′. The fluid dynamic resistance Fᵣₚ depends, as explained before, on the particles cross section (size), on the drag coefficient C_{D} and therefore depends on the Reynolds number of the particle in the fluid, wherein the Reynolds number is the ratio of inert forces to viscous forces which act on the particle in the fluid. The sorting device 100 is adapted to at least temporarily effect a Reynolds number Reₚ of the particle in the fluid, which has at least temporarily a value larger than 0.5 in order to maximize the force, which moves the particle to the right. Since said force is induced by Fᵣₚ, the force depends on the particles size. Therefore, particles are moved with different accelerations and speeds to the right during the displacement process and can be detected in their respective positions as shown in FIG. 14b. Sedimentation occurs but is not shown here.

FIG. 14c shows an embodiment 110 of an detection device according to the present invention, implementing the sorting device of FIG. 14a/b. The detection device shown allows to detect the concentration of a certain type t₁, t₂ or t₃ of particles, which are distinguishable according to their size. To achieve detection, the detection device 110 comprises detection means, which comprise at least one radiation source 12, e.g. an LED with field lens, and at least one corresponding detector 13, e.g. a CCD-detector, placed on opposite sides of the transparent container 7′, which can be a cuvette. The radiation 14, which is transmitted through the fluid at a certain position along the length of the cuvette 7′ from the light source 12 to the detector 13, as characterized by an extinction co-efficient, is a measure for the concentration of the type t₁, t₂ or t₃ of particles having a certain size in the fluid, because it is preferably known from a calibration step, at which distance from the starting position which type of particle must be found after a certain time of the displacement process.

Calibration of the system has preferably already been performed before the sorting step. A calibration can use test particles, which are comparable in shape and density to the particles to be tested and which have a known size composition. For the test particles, the relation (function) for the shifting or distribution distance in dependence on the size is preferably known, and can be have otherwise determined before (e.g. the size measured by known light scattering techniques).

The detection means can be adapted to be movable along direction d₁ to scan the sample (fluid with sorted particles), as shown in FIG. 14c. Alternatively, at least a part of the detection means, for example the detectors could be stationary and provide a sufficient large detection surface, e.g. as large as one side of the container 7′. Instead of a single spot light source, a multiple spot light source can be used, wherein several light sources are distributed along one side of the container, facing a detector on the other side of the transparent container 7′. The spatial resolution of the detection device 110 is in particular dependent on the resolution of the detector, which can be some μm.

FIG. 14d shows an alternative embodiment 120 of a sorting device according to the present invention which implements the apparatus according to the present invention and which is similar to the sorting device 100, which allows to recover the sorted particles from the fluid by moving them through openings 15 in the containers bottom side 16 down into receptacles 17 placed under the openings. This downward motion can be effected by gravity G or induced or increased by a force F, based on a vertical displacement process driven by a shear effect piezo 3′. Particles in the receptacles can be removed from the sorting device by closing the valves 18 and removing the receptacles, which each contain a relative high fraction of a type t₁, t₂ or t₃ of particle in fluid. Particles can be stored or transported through tubes, which are connected to the valves or receptacles. This way, further analysis and use of the particles is possible, which is in particular useful in automated systems, e.g. laboratory robot systems.

FIG. 15a shows in a schematical 3D-drawing another embodiment 130 of a sorting device according to the present invention which implements the apparatus according to the present invention, in a starting position of particles t1, t2 and t3 with different sizes. For simplicity, only the preferably removable container 7″ of the apparatus and the sorting device is shown, which is adapted here as a two-dimensional distribution section 7″. Not shown is the actuating device 3″, which can be a shear effect piezo-actuator or another actuator, which is adapted to perform a motion in more than one direction, e.g. the directions d₁ and d₂ (perpendicular to d₁ and to gravity).

The piezo-element 3″ (not shown) performs a displacement process, which comprises at least temporarily displacements D₁ along direction d₁ and comprises at least temporarily displacements D₂ along direction d₂. The two kind of displacements D₁ and D₂, each having a first velocity v_{C} and a second velocity v_{C2}(≠v_{C1}), can be equal or different, leading to an induced motion of the particles along d₁ and d₂. The displacement process can comprise a repeated sequence of displacements, which comprises D₁ and D₂ in any predetermined order, e.g. comprises Dᵢ followed by D₂, D₂ followed by D₁, D₁ followed by D₁ or D₂ followed by D₂ or other sequences and other kind of displacements. Further, the displacements, in particular D₁ and D₂, can be at least temporarily be performed simultaneously.

FIG. 15b shows the sorting device of FIG. 15a with the sorted particles, which are distributed in the plane defined by the directions d₁ and d₂. Particles start sedimentation from the begin of the displacement process. The time available for the displacement process is in particular depend on the sedimentation time, which is limited by the height H of the container 7″. Additionally, a displacement D₃ along direction d₃ can be applied which results in a force F, which supports or slows the sedimentation motion. At the end of the displacement process, particles are distributed and sorted over the bottom surface 16″ of the container 7″, as shown in FIG. 15c.

Using a calibration scale pattern in FIG. 15c, the concentration of types t₁, t₂ and t₃ of particles can be detected and determined (see description of FIG. 14c). The calibration scale pattern can comprise experimentally data and/or calculated, e.g. inter- and extrapolated data. Detection can be performed, as described before, by light transmission measurements (see description of FIG. 14c). The bottom surface of the transparent distribution section (container) 7″ can be arranged on top of the surface of a CCD-detector-matrix. This allows to photograph the particles by exposure of the CCD-surface, which is masked by the particles, to light.

Alternatively, receptacles may be placed in the container 7″ at its bottom side 16″, to recover the sorted particles. A porous inlay may be placed inside container 7″ on its bottom side 16″, wherein the inlay comprises open pores, which are capable of receiving and holding the particles. Such an inlay can be a tissue-like or spongy material, e.g. porous paper or textile. This allows to remove the fluid from the container and to store and/or dry or easily separate and recover the particles, e.g by cutting the inlay after removal and storing it. Sorted living cells can be kept under cell medium while separating the different kind of cells, e.g. by cutting the inlay, and can be seeded in different Petri dishes again. However, the sorting device and detection device and the respective methods can be applied to any application, where the size of particles have to be determined, e.g. in research laboratories, in the colour and lacquer producing industry and many other technical fields.

FIGS. 16a and 16b are related to an embodiment of the apparatus according to the present invention, which in particular solves the problem that if a solution (e.g. water) evaporates from a sample solution condenses and forms drops adhering at the container walls, the concentration of the solvents in the remaining solution rises. This is solved by driving (shaking off) the drops into the water 21 of the container by means of a displacement process. FIG. 16a shows the embodiment 140 of the apparatus according to the present invention, adapted to perform a shaking motion to shake off water drops 19, which adhere at the wall 20 of the container 7, made of plastic, e.g. polypropylene, by means of a repeated displacement x_{C} of the container. FIG. 16b shows a graph with an example for an appropriate saw-tooth displacement x_{C} of FIG. 16a as a function of time.

The apparatus comprises the piezo-actuator 3 connected to the container 7 and is adapted to perform a shaking motion in vertical direction. Upon the displacement process, the water drops 19 are driven into the water bulk 21. The motion x_{C}(t) of the container, caused by the actuator 3, is preferably a saw-tooth-like shaped function of time. However, other x_{C}(t) are possible to shake off drops, even sinus-shaped functions are possible for vertical displacements. Sinus shaped x_{C} are appropriate to shake off water drops having volumes V_{d}≧0.5 μl. Saw-tooth-like shaped functions x_{C}(t) can even shake off drops of V_{d}<0.5 μl and are in particular effective to move drops adhering to substantially vertical walls, but are also appropriate for more horizontal displacements. Increasing the acceleration x″_{C}(t) or increasing the amplitude A of the motion x_{C} increases the chances to move drops adhering to the wall back to the solution. For a sinus-shaped x_{C}, increasing the frequency f_{C} of the periodical motion x_{C} also increases the chances to move drops adhering to the wall back to the solution. For a saw-tooth-like shaped function x_{C}, the acceleration is substantially independent on the frequency. However, the velocity of the drops travelling along the wall can be increased be increasing f_{C}. To improve moving drops smaller than 0.5 μl, increasing f_{C} and/or A is effective.

Appropriate parameters for the shaking motion are in particular 5 Hz≦f_{C}≦100 Hz, 0.3 mm≦A≦16 mm. However, other parameters are possible.

1. Method for moving particles in a fluid by means of a laboratory apparatus, in particular for moving particles in a fluid at Reynolds numbers larger than 0.5, the apparatus comprising a container section (2) adapted to hold said fluid, the container section comprising at least one container (7), the apparatus adapted to perform a displacement process, which includes a number of repeated displacements of said container section and the apparatus comprising at least one actuating device (3), which is adapted to cause said displacements, comprising the steps:
holding said fluid with said particles in the at least one container of the container section;
performing a displacement process, which includes a number of repeated displacements of said container section, comprising said at least one container, by means of said actuating device;
performing said displacement by performing a first motion of said container section from a first position to a second position and a consecutive motion of said container section from said second position to a consecutive position by means of said actuating device,
wherein during said first motion said container section is at least temporarily moved with a first velocity, and wherein during said consecutive motion said container section is at least temporarily moved with a second velocity, which is different from said first velocity,
applying a force by means of said displacement process upon said particles in the fluid, which is caused by the fluid-dynamic resistance Fᵣₚ of the particles in the fluid and which is capable of inducing a directed motion of said particles in relation to said container section, wherein said first and second velocity of said container section control said motion of the particles.

2. Method according to claim 1 characterized in that the displacements cause at least temporarily a Reynolds number larger than 0.5 of the particles.

3. Method according to any of the claim 1 or 2 characterized in that the direction of the motion of said particles is dependent on the directions of said first and second velocity.

4. Method according to any of the previous claims characterized in that said force is capable of inducing a velocity x′ᵣₑₗ of said particles relative to said container section, wherein said force is dependent on x′ᵣₑₗ² and in particular on x″ᵣₑₗ.

5. Method according to any of the previous claims characterized in that the motions of displacement, including said first and second motion of said container section are following a predetermined pathway, which is expressed by the displacement x_{C}(t) or the velocity function vet) as a function of time.

6. Method according to claim 5 characterized in that v_{C}(t) comprises v_{1C}(t)ᵢ, which corresponds to said first motion and first velocity and comprises v_{2C}(t)ᵢ, which corresponds to said second motion and second velocity.

7. Method according to claim 6 characterized in that the average of v_{1C}(t)ᵢ is different to the average of v_{2C}(t)ᵢ.

8. Method according to claim 5 characterized in that x_{C}(t) is a periodical function of time with the period T, the amplitude A and the frequency f_{C}.

9. Method according to claim 8 characterized in that for the same predetermined frequency f_{C} and the same amplitude A, the motion of the particles is increased by further reducing the lower one of the velocities v_{C1}(t) and v_{C2}(t).

10. Method according to claim 8 or 9 characterized in that for the same predetermined frequency f_{C} and the same amplitude A, the motion of the particles is increased by further increasing the higher one of the velocities v_{C1}(t) and v_{C2}(t).

11. Method according to any of the claims 8 to 10 characterized in that for the same amplitude A, the motion of the particles is increased by increasing the frequency f_{C}.

12. Method according to any of the claims 8 to 11 characterized in that for the same frequency f_{C}, the motion of the particles is increased by increasing the amplitude A.

13. Method according to claim 5 and any of the previous claims characterized in that x_{c}(t) is a non-sinusoidal periodic function.

14. Method according to claim 5 and any of the previous claims characterized in that x_{c}(t) is a sawtooth-like function.

15. Method according to any of the previous claims characterized in that the term “Reynolds number” refers to the maximum value Reₘₐₓ of the particles Reynolds number in the fluid, which in particular depends on the particles velocity.

16. Method according to claim 15 characterized in that a first Reynolds number Re₁ is assigned to the first motion and a second Reynolds number Re₂ is assigned to the second or consecutive motion, wherein Re₁≠Re₂.

17. Method according to claim 5 and any of the previous claims characterized in that the displacement function x_{C}(t) and/or the displacement velocity function v_{C}(t) are determined such that during one of said first or consecutive (e.g. second) motion the particle's Reynolds number is closer to the Newton region (Reₚ>1000) than during the respective other motion.

18. Method according to at least one of the previous claims characterized in that a displacement process is performed, which increases or decreases the relative velocity x′ᵣₑₗ of particles in relation to said container section.

19. Method according to at least one of the previous claims characterized in that the drag coefficient C_{D} of the fluid is in the Newton region.

20. Method according to at least one of the previous claims 1 to 19 which is using the apparatus according to at least one of the claims 22 to 31.

21. Sorting method for sorting particles according to a physical parameter using the method steps of any of the claims 1 to 20, and further comprising the step of using said motion of the particles to distribute the particles in a distribution section.

22. Detection method, comprising the steps of the sorting method according to claim 21 and further comprising the step of detecting at least one physical property of one type of the particles, which are sorted by means of the sorting device, by detection means.

23. Laboratory apparatus (1), in particular for moving particles in a fluid at Reynolds numbers larger than 0.5, comprising:
a container section (2) adapted to hold said fluid, the container section comprising at least one container (7),
the apparatus adapted to perform a displacement process, which includes a number of repeated displacements of said container section,
at least one actuating device (3), which is adapted to cause said displacements,
said displacement comprising a first motion of said container section from a first position to a second position and a consecutive motion of said container section from said second position to a consecutive position,
wherein during said first motion said container section is at least temporarily moved with a first velocity, and wherein during said consecutive motion said container section is at least temporarily moved with a second velocity, which is different from said first velocity,
wherein by means of said displacement process, a force is acting upon said particles in the fluid, which is caused by the fluid-dynamic resistance Fᵣₚ of the particles in the fluid and which is capable of inducing a directed motion of said particles in relation to said container section, wherein said first and second velocity of said container section control said motion of the particles, and
wherein, preferably, the displacements cause at least temporarily a Reynolds number larger than 0.5 of the particles.

24. Laboratory apparatus according to claim 23 characterized in that the actuating device is adapted such that the direction of displacement of said container section is variable in all directions in space, whereby the direction of motion of said particles in the fluid can be controlled.

25. Laboratory apparatus according to claim 23 or 24 characterized in that it comprises a plurality of actuating devices, each being connected to said container section and adapted to contribute to said displacement process.

26. Laboratory apparatus according to at least one of the claims 23 to 25 characterized in that it comprises a control device, which is adapted to control said displacement, i.e. said first motion and said second motion.

27. Laboratory apparatus according to at least one of the claims 23 to 26 characterized in that said container section comprises at least one first section and at least one second section, which is adjacent and connected to said first section, said first and second section being each adapted to hold at least one fluid containing initially a mix of at least two types of particles, wherein said mix comprises at least one first type of particle related to a first Reynolds number, and at least one second type of particle related to a second Reynolds number, which is different from said first Reynolds number, the apparatus being adapted to separate said mix of particles by performing a displacement process by means of said at least one actuating device, such that said first type of particles becomes concentrated in said first section and said sec- and type of particles becomes concentrated in said second section.

28. Laboratory apparatus according to at least one of the claims 23 to 27 characterized in that said container section comprises at least one first section and at least one second section, which is adjacent and connected to said first section, said first and second section being adapted to hold at least one fluid containing at least two types of particles, i.e. at least one first type of particle related to a first Reynolds number, and at least one second type of particle related to a second Reynolds number, which is different from said first Reynolds number, said first section being adapted to initially hold particles in high concentration, the apparatus being adapted to mix said particles from said first section of high concentration into said second section by performing a displacement process by means of said at least one actuating device, such that said particles become distributed with a lower concentration in said first and second section.

29. Laboratory apparatus according to at least one of the claims 23 to 28 characterized in that it comprises at least one connecting device (4), which connects said container section to said actuating device.

30. Laboratory apparatus according to at least one of the claims 23 to 29 which is adapted to run the method according to at least one of the subsequent claims.

31. Laboratory apparatus according to at least one of the claims 23 to 30 wherein the actuating device comprises an piezoelectric actuator.

32. Laboratory apparatus according to at least one of the claims 23 to 31 which comprises the fluid, which comprises the particles.

33. Use of an laboratory apparatus according to at least one of the claims 23 to 32 to separate particles, in particular with Reynolds numbers larger than 0.5, from a fluid by moving said particles toward the bottom of a container, which is comprised by said container section.

34. Use of an laboratory apparatus according to at least one of the claims 23 to 32 to mix particles with Reynolds numbers larger than 0.5, which are concentrated in at least one section of the fluid in said container section, by moving said particles into the fluid.

35. Use of an laboratory apparatus according to claim 29 for performing a shaking motion of a container section, which contains said fluid.

36. Sorting device (100; 120; 130) for sorting particles according to a physical parameter, comprising the laboratory apparatus according at least one of the claims 22 to 31, and further comprising a distribution section (7′) to hold the fluid with the particles, which is assigned to the container section.

37. Detection device (110), comprising the sorting device according to claim 36, and further comprising detection means (12, 13) to detect at least one physical property of one type of the particles in the fluid, which are sorted by means of the sorting device.

38. Computer code to control the displacements of the container section of the apparatus according any of the claims 23 to 32.
